(19) United States
(12) Patent Application Publication
(10) Pub. No.: US 2026/0203572 A1
(43) Pub. Date: Jul. 16, 2026

(54) GENERATIVE PRETRAINING OF MULTIMODAL RETRIEVAL-AUGMENTED VISUAL-LANGUAGE MODELS

(71) Applicant: Google LLC, Mountain View, CA (US)

(72) Inventors: David Ross, San Jose, CA (US); Zirui Wang, Mountain View, CA (US); Ziniu Hu, Los Angeles, CA (US); Cordelia Schmid, Saint-Ismier (FR); Chen Sun, San Francisco, CA (US); Alireza Fathi, Mountain View, CA (US); Ahmet Iscen, Seyssinet-Pariset (FR)

(21) Appl. No.: 19/129,947

(22) PCT Filed: Nov. 28, 2023
(86) PCT No.: PCT/US2023/081306

§ 371 Date: May 14, 2025

Related U.S. Application Data
(60) Provisional application No. 63/428,891, filed on Nov. 30, 2022.
(60) Provisional application No. 63/429,204, filed on Dec. 1, 2022.

(51) Int. Cl. G06N 3/08

(52) U.S. Cl. CPC G06N 3/08

(57) ABSTRACT

Systems and methods for end-to-end pretraining of multimodal retrieval-augmented visual language models. In some examples, multimodal information may be encoded into key-value pairs and stored in a unified memory, which the model's retriever can access via multimodal query encodings in order to identify relevant information within multiple knowledge sources. The model may include an attentive fusion layer so that automatically-generated retrieval scores for multiple simultaneously-considered documents may b used in calculating attention scores, and gradients from the final task may be used to train the entire model (including the retriever) end-to-end and update the unified memory. In such cases, the retriever may thus be trained with the rest of the model without the need for ground-truth scores indicating which knowledge entries are most helpful in answering a given query, and the model's parameters may thus be focused on understanding queries and conducting reasoning rather than simply memorizing the training data.

### CROSS-REFERENCE TO RELATED APPLICATIONS

This application claims priority to and the benefit of the filing date of U.S. Provisional Patent Application No. 63/428,891, filed Nov. 30, 2022, and priority to and the benefit of the filing date of U.S. Provisional Patent Application No. 63/429,204, filed Dec. 1, 2022, the entire disclosures of which are expressly incorporated by reference herein.

### BACKGROUND

Many large-scale models (e.g., T5, GPT-3, PaLM, CoCa, Flamingo, BEIT-3, PaLI, etc.) may store a surprising amount of world knowledge, particularly when those models are scaled to tens of billions of parameters and trained on vast text and image corpora. Such large-scale models may achieve state-of-the-art results when fine-tuned and applied to downstream tasks such as image captioning, visual question answering (“VQA”) and open vocabulary recognition. However, such models may also have a number of drawbacks. For example, such models may require massive scale in terms of parameters, training data, and computing resources, in order to achieve such results. In addition, as such models store their knowledge in their model weights, they may require retraining to incorporate new knowledge.

### SUMMARY

The present technology is related to systems and methods for end-to-end pretraining of multimodal retrieval-augmented visual-language models (which may be referred to herein as “REVEAL”). In that regard, instead of compiling the world knowledge statically into model weights, the present technology may be used to transform such knowledge into a key-value memory using neural representation learning which the model in turn learns to use for answering knowledge-intensive queries. For example, in some aspects of the technology, the various sources of multimodal world knowledge may be encoded and stored into a unified memory, which the retriever can access via multimodal query encodings in order to find relevant information within multiple complementary sources of the knowledge corpus. In such a case, the multimodal memory and retriever may be pre-trained end-to-end together with the rest of the model.

For example, in some aspects of the technology, the model may be configured to include an attentive fusion layer so that automatically-generated retrieval scores for multiple simultaneously-considered documents may be used in calculating attention scores, and gradients from the final task may be used to train the entire model (including the parameters of the retriever module) and update the unified memory. By decoupling the knowledge memorization from reasoning in this way, models trained according to the present technology may learn to leverage various external sources of knowledge (e.g., Wikipedia passages and images, the Wiki-Data knowledge graph, Web image-text pairs, visual question answering data, etc.).

As a result, the model's parameters may focus on understanding queries and conducting reasoning instead of being dedicated solely to memorizing the content of the training data. In some cases, this may enable models trained according to the present technology to achieve state-of-the-art performance on knowledge-intensive visual question answering and image captioning datasets (e.g., the outside-knowledge visual question answering “OKVQA” benchmark), while using up to an order of magnitude fewer parameters than large-scale models trained according to other methods.

In one aspect, the disclosure describes a computer-implemented method of training a retrieval-augmented model, comprising: (1) for each given training example of a plurality of training examples, the given training example including a model input and a target output: encoding the model input, using an encoder of the retrieval-augmented model, to generate a query embedding; retrieving, using a retrieval module of the retrieval-augmented model, a plurality of knowledge items from a corpus based at least in part on the query embedding and a plurality of knowledge item embeddings, each given knowledge item embedding of the plurality of knowledge item embeddings being based on a given knowledge item in the corpus; generating, using the retrieval module of the retrieval-augmented model, a retrieval score for each item of the plurality of knowledge items, the retrieval score for a given item representing a prediction of relevance of the given item to the model input; generating, using a generator of the retrieval-augmented model, a predicted output based at least in part on the query embedding, the plurality of knowledge items, and the retrieval score for each item of the plurality of knowledge items; and comparing, using one or more processors of a processing system, the predicted output to the target output to generate a loss value for the given training example; and (2) modifying, using the one or more processors, one or more parameters of the encoder, one or more parameters of the retriever module, and one or more parameters of the generator of the retrieval-augmented model based at least in part on the loss values generated for the plurality of training examples. In some aspects, the plurality of knowledge item embeddings comprises a key-value embedding pair for each knowledge item in the corpus.

In some aspects, the method further comprises generating, using the retrieval-augmented model, each given knowledge item embedding of the plurality of knowledge item embeddings based on a given knowledge item in the corpus. In some aspects, the method further comprises modifying, using the one or more processors, one or more knowledge item embeddings of the plurality of knowledge item embeddings based at least in part on the loss values generated for the plurality of training examples. In some aspects, one or more of the plurality of knowledge items in the corpus comprises text data. In some aspects, one or more of the plurality of knowledge items in the corpus comprises image data. In some aspects, one or more of the plurality of knowledge items in the corpus comprises audio data. In some aspects, one or more of the plurality of knowledge items in the corpus comprises video data. In some aspects, the model input of at least one of the plurality of training examples comprises text data. In some aspects, the model input of at least one of the plurality of training examples comprises image data.

Moreover, in some aspects, the model input of at least one of the plurality of training examples comprises audio data. In some aspects, the model input of at least one of the plurality of training examples comprises video data. In some aspects, the method further comprises generating, using the one or more processors, a given training example of the plurality of training examples based on a given knowledge item of the plurality of knowledge items. In some aspects, generating the given training example comprises masking a portion of the knowledge item to generate the model input. In some aspects, generating the given training example comprises using some or all of the given knowledge item as the target output.

In another aspect, the disclosure describes a non-transitory computer program product comprising computer readable instructions that, when executed by a processing system, cause the processing system to perform any of the methods described in the preceding paragraph.

In a further aspect, the disclosure describes a processing system comprising: (1) a memory storing a retrieval-augmented model; and (2) one or more processors coupled to the memory and configured to train the retrieval-augmented model according to a training method comprising: (a) for each given training example of a plurality of training examples, the given training example including a model input and a target output: encoding the model input, using an encoder of the retrieval-augmented model, to generate a query embedding; retrieving, using a retrieval module of the retrieval-augmented model, a plurality of knowledge items from a corpus based at least in part on the query embedding and a plurality of knowledge item embeddings, each given knowledge item embedding of the plurality of knowledge item embeddings being based on a given knowledge item in the corpus; generating, using the retrieval module of the retrieval-augmented model, a retrieval score for each item of the plurality of knowledge items, the retrieval score for a given item representing a prediction of relevance of the given item to the model input; generating, using a generator of the retrieval-augmented model, a predicted output based at least in part on the query embedding, the plurality of knowledge items, and the retrieval score for each item of the plurality of knowledge items; and comparing, using the one or more processors, the predicted output to the target output to generate a loss value for the given training example; and (b) modifying, using the one or more processors, one or more parameters of the encoder, one or more parameters of the retriever module, and one or more parameters of the generator of the retrieval-augmented model based at least in part on the loss values generated for the plurality of training examples.

In some aspects, the one or more processors are further configured to generate, using the retrieval-augmented model, each given knowledge item embedding of the plurality of knowledge item embeddings based on a given knowledge item in the corpus. In some aspects, the training method further comprises modifying, using the one or more processors, one or more knowledge item embeddings of the plurality of knowledge item embeddings based at least in part on the loss values generated for the plurality of training examples. In some aspects, the one or more processors are further configured to generate a given training example of the plurality of training examples based on a given knowledge item of the plurality of knowledge items. In some aspects, the one or more processors are further configured to generate the given training example by masking a portion of the knowledge item to generate the model input.

Moreover, in some aspects, the one or more processors are further configured to generate the given training example by using some or all of the given knowledge item as the target output. In some aspects, the retrieval-augmented model is a transformer. In some aspects, the training method further comprises, for each given training example of the plurality of training examples: generating, using an attentive fusion module of the retrieval-augmented model, an attention score based at least in part on the retrieval score for each item of the plurality of knowledge items; and the one or more processors are further configured to generate the predicted output based at least in part on the attention score. In some aspects, the retrieval-augmented model is a retrieval-augmented visual-language model.

### BRIEF DESCRIPTION OF THE DRAWINGS

FIG. 1 is a functional diagram of an example system in accordance with aspects of the disclosure.

FIG. 2 is a functional diagram of an example system in accordance with aspects of the disclosure.

FIG. 3 is a flow chart illustrating an exemplary process flow for training of a retrieval-augmented visual-language model, in accordance with aspects of the disclosure.

FIG. 4A is a flow chart illustrating an exemplary process flow for processing an input query and generating an output using a retrieval-augmented visual-language model, in accordance with aspects of the disclosure. FIGS. 4B-D are enlarged views of different sections of FIG. 4A

FIG. 5 is a flow chart illustrating an exemplary process flow for an attentive knowledge fusion module of a retrieval-augmented visual-language model, in accordance with aspects of the disclosure.

FIG. 6 illustrates a table of knowledge sources used in testing in accordance with aspects of the disclosure.

FIG. 7 illustrates model configurations of different variants in accordance with aspects of the disclosure.

FIG. 8 illustrates a table of VQA test results in accordance with aspects of the technology.

FIG. 9 illustrates another table of VQA test results in accordance with aspects of the technology.

FIG. 10 illustrates example from VQA datasets, in accordance with aspects of the technology.

FIG. 11 illustrates a table of image captioning results in accordance with aspects of the technology.

FIG. 12 illustrates an ablation study of OKVQA accuracy using (1) Only-One-Left and (2) Leave-One-Out), in accordance with aspects of the technology.

FIG. 13 illustrates an ablation study of OKVQA accuracy using all pairs of knowledge sources, in accordance with aspects of the technology.

FIG. 14 illustrates a table of results for an analysis of retrieval training in accordance with aspects of the technology.

FIG. 15 is a chart of text results in accordance with aspects of the technology.

FIG. 16 illustrates examples of visual question answering and image captions in accordance with aspects of the technology.

FIG. 17 illustrates other examples of visual question answering and image captions in accordance with aspects of the technology.

FIGS. 18A-D illustrate further examples of visual question answering and image captions in accordance with aspects of the technology.

FIG. 19 illustrates a table of results for hyperparameter sensitivity analysis in accordance with aspects of the technology.

FIG. 20 illustrates a table of results for ablation on a pre-training corpus in accordance with aspects of the technology.

FIG. 21 illustrates a table of results for a comparison with visual-only retrieval in accordance with aspects of the technology.

FIG. 22 illustrates an example algorithm for a Perceiver operation in accordance with aspects of the technology.

FIG. 23 illustrates an example algorithm for an Attentive Fusion operation in accordance with aspects of the technology.

FIG. 24 illustrates an example algorithm for online distributed MIPS retrieval in accordance with aspects of the technology.

FIG. 25 illustrates a flow diagram of a method in accordance with aspects of the disclosure.

### DESCRIPTION

The present technology will now be described with respect to the following exemplary systems and methods. Reference numbers in common between the figures depicted and described below are meant to identify the same features.

### Example Systems

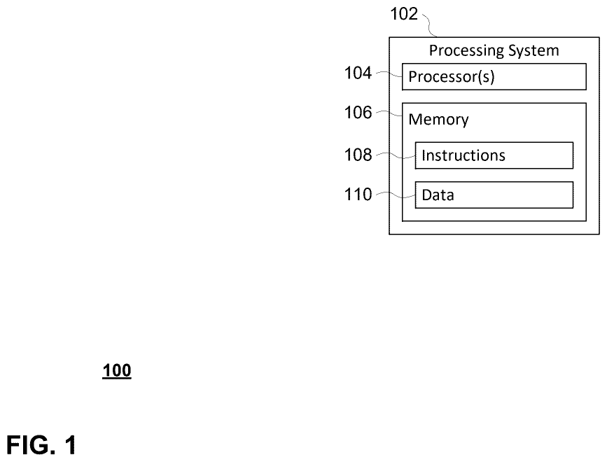

FIG. 1 shows a high-level system diagram 100 of an exemplary processing system 102 for performing the methods described herein. The processing system 102 may include one or more processors 104 and memory 106 storing instructions 108 and data 110. The instructions 108 and data 110 may include a retrieval-augmented model (e.g., a retrieval-augmented visual-language model), as described further below. In addition, the data 110 may store data based on entries of a knowledge corpus (e.g., key-value embedding pairs for each such entry), training examples to be used in training the model, outputs from the model produced during training, training signals and/or loss values generated during such training, and/or outputs from the model generated during inference.

Processing system 102 may be resident on a single computing device. For example, processing system 102 may be a server, personal computer, or mobile device, and the model may thus be local to that single computing device. Similarly, processing system 102 may be resident on a cloud computing system or other distributed system. In such a case, the model may be distributed across two or more different physical computing devices. For example, the processing system may comprise a first computing device storing layers 1-n of a model having m layers, and a second computing device storing layers n-m of the model. In such cases, the first computing device may be one with less memory and/or processing power (e.g., a personal computer, mobile phone, tablet, etc.) compared to that of the second computing device, or vice versa. Likewise, in some aspects of the technology, the processing system may comprise one or more computing devices storing one or more parts of a model, and one or more separate computing devices storing other parts of the model. For example, in some aspects, the processing system may comprise one or more computing devices sorting the model's unified memory, and one or more separate computing devices storing the model's query encoder, knowledge retriever, and answer generator. Further, in some aspects of the technology, data used and/or generated during training or inference of the model (e.g., training examples, model outputs, loss values, etc.) may be stored on a different computing device than the model.

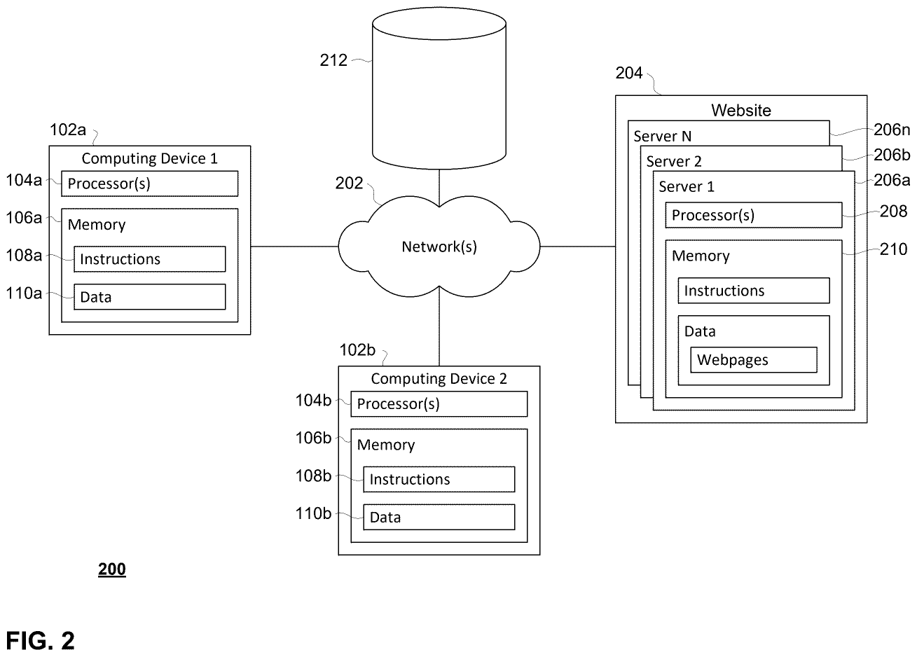

Further in this regard, FIG. 2 shows a high-level system diagram 200 in which the exemplary processing system 102 just described is distributed across two computing devices 102a and 102b, each of which may include one or more processors (104a, 104b) and memory (106a, 106b) storing instructions (108a, 108b) and data (110a, 110b). The processing system 102 comprising computing devices 102a and 102b is shown being in communication with one or more websites and/or remote storage systems over one or more networks 202, including website 204 and remote storage system 212. In this example, website 204 includes one or more servers 206a-206n. Each of the servers 206a-206n may have one or more processors (e.g., 208), and associated memory (e.g., 210) storing instructions and data, including the content of one or more webpages. Likewise, although not shown, remote storage system 212 may also include one or more processors and memory storing instructions and data. In some aspects of the technology, the corpus of knowledge from which the model is trained to retrieve data may be comprised of one or more websites such as website 204 and/or one or more remote storage systems such as remote storage system 212. Likewise, in some aspects, the processing system 102 may not be in direct communication with any websites, and may instead be configured to retrieve documents from stored versions of one or more websites (e.g., stored on remote storage system 212). Further, in some aspects, rather than (or in addition to) websites or stored versions thereof, the corpus may comprise one or more other sources of information such as databases, copies of literature, publications, newspapers, reference books, etc. As will be appreciated, the present technology may be adapted to any suitable topology and type of corpus.

The processing systems described herein may be implemented on any type of computing device(s), such as any type of general computing device, server, or set thereof, and may further include other components typically present in general purpose computing devices or servers. Likewise, the memory of such processing systems may be of any non-transitory type capable of storing information accessible by the processor(s) of the processing systems. For instance, the memory may include a non-transitory medium such as a hard-drive, memory card, optical disk, solid-state, tape memory, or the like. Computing devices suitable for the roles described herein may include different combinations of the foregoing, whereby different portions of the instructions and data are stored on different types of media.

In all cases, the computing devices described herein may further include any other components normally used in connection with a computing device such as a user interface subsystem. The user interface subsystem may include one or more user inputs (e.g., a mouse, keyboard, stylus, touch screen, and/or microphone) and one or more electronic displays (e.g., a monitor having a screen or any other electrical device that is operable to display information). Output devices besides an electronic display, such as speakers, lights, and vibrating, pulsing, or haptic elements, may also be included in the computing devices described herein.

The one or more processors included in each computing device may be any conventional processors, such as commercially available central processing units (“CPUs”), graphics processing units (“GPUs”), tensor processing units (“TPUs”), etc. Alternatively, the one or more processors may be a dedicated device such as an ASIC or other hardware-based processor. Each processor may have multiple cores that are able to operate in parallel. The processor(s), memory, and other elements of a single computing device may be stored within a single physical housing, or may be distributed between two or more housings. Similarly, the memory of a computing device may include a hard drive or other storage media located in a housing different from that of the processor(s), such as in an external database or networked storage device. Accordingly, references to a processor or computing device will be understood to include references to a collection of processors or computing devices or memories that may or may not operate in parallel, as well as one or more servers of a load-balanced server farm or cloud-based system.

The computing devices described herein may store instructions capable of being executed directly (such as machine code) or indirectly (such as scripts) by the processor(s). The computing devices may also store data, which may be retrieved, stored, or modified by one or more processors in accordance with the instructions. Instructions may be stored as computing device code on a computing device-readable medium. In that regard, the terms “instructions” and “programs” may be used interchangeably herein. Instructions may also be stored in object code format for direct processing by the processor(s), or in any other computing device language including scripts or collections of independent source code modules that are interpreted on demand or compiled in advance. By way of example, the programming language may be C#, C++, JAVA or another computer programming language. Similarly, any components of the instructions or programs may be implemented in a computer scripting language, such as JavaScript, PHP, ASP, or any other computer scripting language. Furthermore, any one of these components may be implemented using a combination of computer programming languages and computer scripting languages.

### Example Architecture and Methods

The REVEAL model comprises four main components: the memory, the encoder, the retriever and the generator. The large-scale memory is configured to encode various sources of multimodal world knowledge (e.g., image-text pairs, question answering pairs, knowledge graph triplets, etc.) via a unified encoder. The retriever is configured to find the most relevant knowledge entries in the memory, and the generator is configured to fuse the retrieved knowledge with the input query to produce the output. The memory, encoder, retriever and generator can all be pre-trained (preferably jointly trained) end-to-end on a massive amount of data. Furthermore, this approach can use a diverse set of multimodal knowledge sources, which is shown to result in significant gains. Moreover, as discussed further below, testing has shown that the REVEAL model architecture achieves state-of-the-art results on visual question answering and image captioning.

The model learns to use knowledge from different sources for solving knowledge-intensive tasks. For both pre-training and fine-tuning, a goal is to learn the distribution P(y|x) to generate a textual output y conditioned on a multimodal input query x. Given an input query x, the system first retrieve K possibly helpful entries M={m₁, . . . , mₓ} from the memory corpora [symbol] . Each m is a memory entry containing the encoded single key embedding and a sequence of value embeddings. With it, the retriever can use embedding similarity to find relevant memory entries. This retrieval process is modeled as sampling from distribution p(M|x). Then, the system condition on both the retrieved set M and the original input query x to generate the output y, modeled as p(y|x, M). To obtain the overall likelihood of generating y, the system can treat M as a latent variable from whole memory [symbol] and marginalize over it yielding:

$$p ( y \vert x ) = {\sum }_{M ⊂ \tilde{ℳ}} {\underbrace{p ( M \vert x )}}_{retrieval} \cdot {\underbrace{p ( y \vert x , M )}}_{generation} . \qquad ( 1 )$$

However, this marginal probability involves an intractable summation over all size-K subsets of the memory corpora M. This can instead be approximated by using the top-K entries in memory with the highest probability under p(M|x). This is suitable if most of the unrelated memory entries do not contribute to the generation. Note that an online memory can be used, which is updatable as the knowledge encoder is trained end-to-end with the rest of the model.

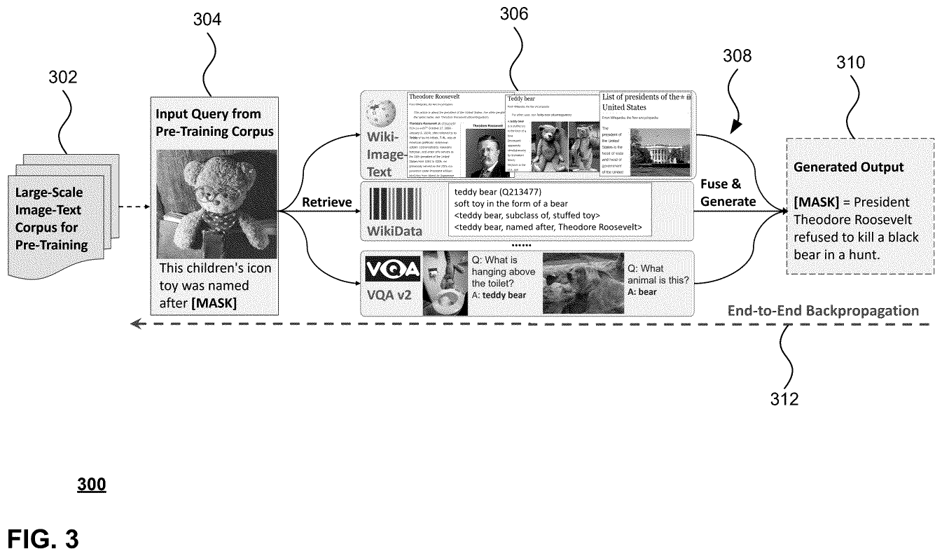

FIG. 3 is a flow chart illustrating an exemplary process flow 300 for training of a retrieval-augmented visual-language model, in accordance with aspects of the disclosure. In particular, this figure shows augment of a visual-language model with the ability to retrieve multiple knowledge entries from a diverse set of knowledge sources, which helps generation. Both retriever and generator may be trained jointly, end-to-end, by optimizing a language modeling objective. The model is able to learn to encode world knowledge into a large-scale memory, and to retrieve from it to answer knowledge-intensive queries.

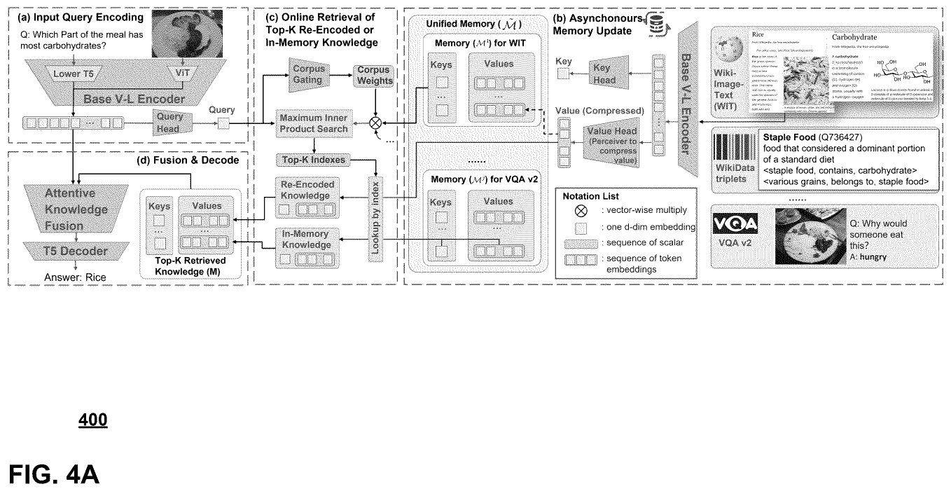

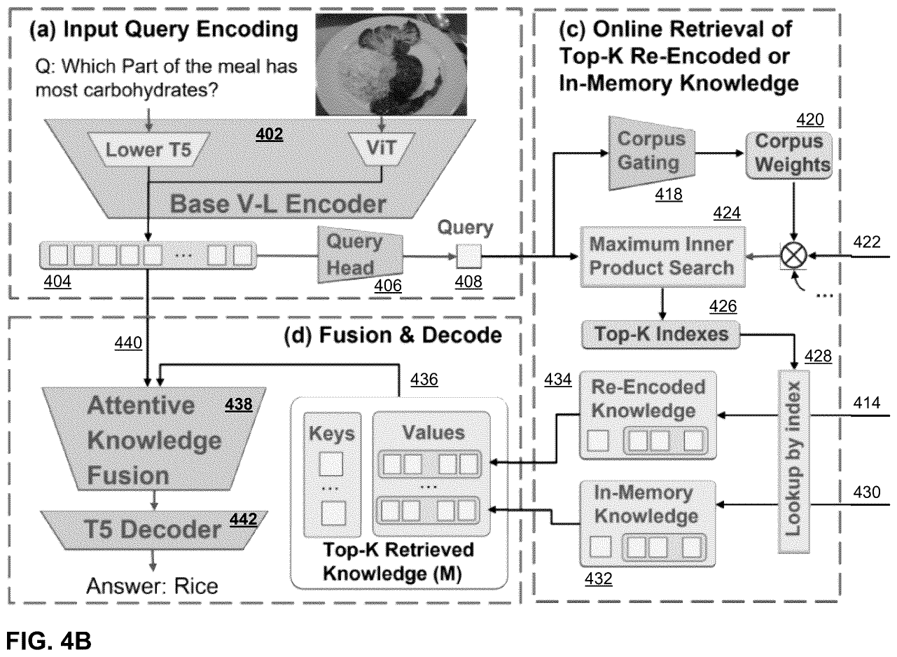

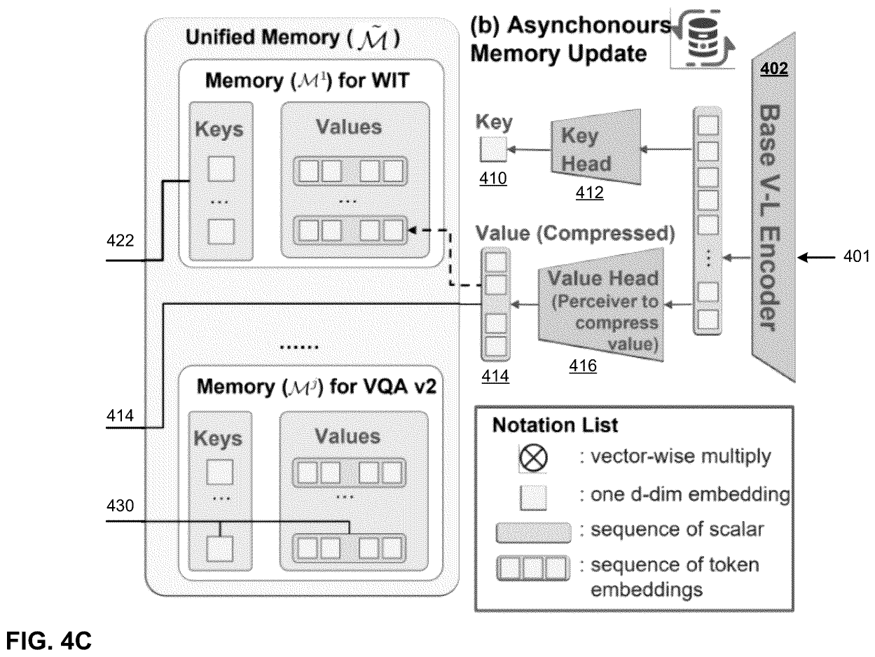

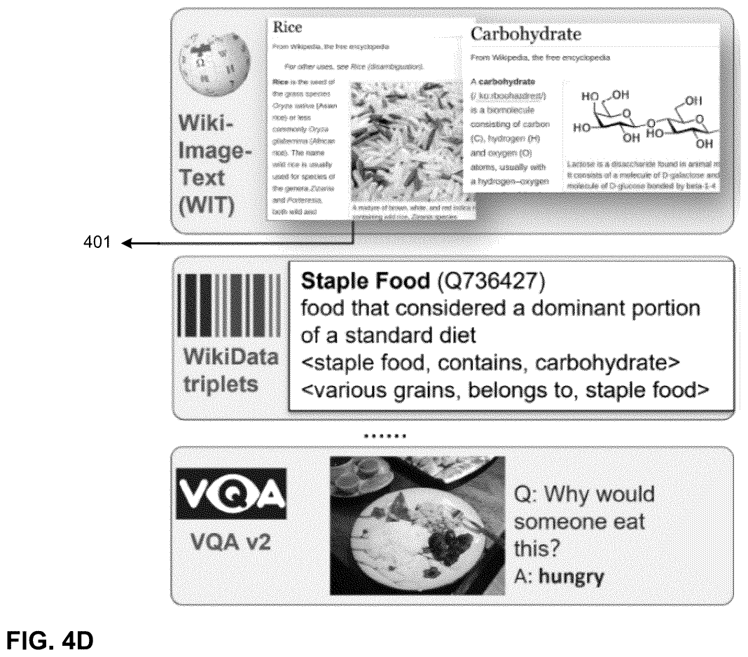

In that regard, FIG. 3 illustrates, at a high level, how an exemplary entry from pre-training corpus 302 may be masked at block 304 and used to retrieve multiple potentially relevant knowledge entries as shown in the examples at 306. As shown, these potentially relevant knowledge entries may then be fused (e.g., as described further below with respect to FIGS. 4A-D and 5) as shown by arrows 308, in order to generate a final generated output 310 representing the model's prediction for the masked portion of the input query. The known ground-truth value for the masked portion of the input query may then be used to generate one or more training gradients that may be used during end-to-end backpropagation 312 to tune the parameters of the entire model, including those of the query encoder, knowledge retriever, and answer generator. In addition, the key-value embeddings in the model's unified memory may be recomputed according to any suitable schedule (e.g., continuously, or after some predetermined number of backpropagation steps) as the model parameters are updated.

FIG. 4A is a flow chart illustrating an exemplary process flow 400 for processing an input query and generating an output using a retrieval-augmented visual-language model, in accordance with aspects of the disclosure.

A base visual-language encoder b(⋅) can be used to turn the query input and each knowledge item (with potentially different modalities e.g., text-only, image-only or image-text pairs) into a sequence of embeddings (tokens). In one configuration, a Vision Transformer (ViT), such as described by Kolesnikov et al. in “An image is worth 16×16 words: Transformers for image recognition at scale” (2021), can be employed to encode the images. A lower-layer T5 encoder, such as described by Raffel et al. in “Exploring the limits of transfer learning with a unified text-to-text transformer” (2020), can be used to encode the texts. Both of these references are incorporated herein by reference in their entireties. As used here, the last l layers of a T5 encoder are denoted as “upper-layers”, and the remaining ones including the token embedding layer as “lower-layers”.

A projection layer can be added on top of the ViT model to map the image tokens into the same space as the text tokens. The two modalities are then concatenated together. An upper-layer T5 module may be used as both the query Head φ_{Query}(⋅) and the key Head φ_{Key}(⋅) to compute the query embedding and memory keys. The output of the first [CLS] tokens are taken, followed by a linear projection and L2-normalization to summarize the input into a d-dimensional embedding. Note that while a ViT transformer and a T5-type encoder are discussed, other transformers (or other types of neural networks) and other encoder configurations may be employed.

The various sections of FIG. 4A, illustrated in the enlarged views of FIGS. 4B-D, present four parts of the overall approach: (a) input query encoding, (b) asynchronous memory updating, (c) online retrieval of top-K re-encoded or in-memory knowledge, and (d) fusion and decoding. More particularly, part (a) involves encoding a multimodal input (text-only, image-only or image-text pair) into a sequence of token embeddings, which are processed by a query head to get a single query embedding. Part (b) encodes each knowledge entry from corpus into key and value embedding pairs, where key is used to index the memory and value contains full information of the knowledge. The embeddings of multiple knowledge sources are updated into a unified knowledge memory. Part (c) retrieves top-K relevant knowledge items by first assigning weights to corpus via a gating network, and next finds the most similar knowledge items from corresponding corpus memory. Afterwards, this part returns either the pre-computed in-memory value embeddings or re-encodes the raw knowledge data to get up-to-date value embeddings as retrieved top-K knowledge. Finally, part (d) fuses the top-k knowledge items via the attentive knowledge fusion layer. The retrieval score can be injected as a prior every time the system calculates the attention. These parts and their features are discussed in detail below.

In this regard, FIG. 4A illustrates an exemplary overall workflow of a retrieval-augmented visual-language model, and FIG. 4D illustrates various types of multimodal inputs 401 to the model. In this example, the workflow includes four main tasks. As shown in dashed box (a), which is enlarged in FIG. 4B, the model's encoder 402 (e.g., a base V-L encoder using a ViT-type transformer and a lower T5 encoder) is configured to encode a given multimodal input (e.g., text-only, image-only, image-text pair) into a sequence of token embeddings. As shown, the multimodal input includes a question (“Which part of the meal has most carbohydrates”) and an image (here, a plate with food on it). In this example, it is assumed that the resulting token embeddings 404 will then be processed by a query head 406 to get a single query embedding 408.

As shown in dashed box (b) (see also FIG. 4C), the model is configured to encode each knowledge entry from the knowledge corpus into “key” and “value” embedding pairs. In this example, it is assumed that each value includes the full information of a given knowledge entry, and the key for that entry will be used to index the model's memory. The embeddings for each entry in multiple knowledge sources may be combined into a single unified knowledge memory for the model.

In particular, section (b) shows how memory is constructed and updated by encoding knowledge items. One notable difference of this method in comparison to previous approaches is that the present method leverages a diverse set of multimodal knowledge corpora (e.g., WikiData knowledge graph, Wikimedia passages and images, Web image-text pairs, etc.). As used herein, each corpus is denoted as

$${\text{?}}^{j} = \{ {z}_{1}^{j} , … , {z}_{N}^{j} \} ,$$

in which each

$${z}_{i}^{j} ϵ {\text{?}}^{j}$$

is a knowledge item that could be an image-text pair, text only, image only, or a triplet from a knowledge graph. The unified knowledge corpus is denoted as [symbol] = [symbol] ¹∪ [symbol] ² . . . [symbol] ^{S} that combines | [symbol] |=S different knowledge corpora.

The external knowledge corpora are encoded into a unified memory [symbol] =[ [symbol] ¹, . . . , [symbol] ] using neural representation learning. Each knowledge item z; is encoded into a key/value pair mᵢ=(Emb_{Key}(zᵢ), Emb_{Value}(zᵢ)) in memory. Each key Emb_{Key}(z)=φ_{Key}(b(z))∈ [symbol] ^{d}, 410 in FIG. 4C, is a d-dimensional embedding vector encoded via Key Head 412. Each value 414 is a sequence of token embeddings representing the full information of knowledge item z. Each knowledge item is encoded into key/value pair, and indexed into the memory. One or more processors of the system can precompute key/value embeddings of knowledge items from different sources and store them in a unified knowledge memory. The memory key/value embeddings may continuously be re-computed as the model parameters get updated during the pre-training phase. By way of example, the system may update the memory [symbol] asynchronously at every 1000 training steps (or at more or less training steps).

A naive solution for encoding the memory value is to keep the whole sequence of tokens for each knowledge item. Then, the generator could fuse the input query and the top-K retrieved memory values by concatenating all their tokens together and feeding them into a Transformer Encoder-Decoder pipeline, such as the one described by Lewis et al. in “Retrieval-augmented generation for knowledge-intensive NLP tasks” (2020), the entire disclosure of which is incorporated herein by reference. This approach has two issues: (1) storing hundreds of millions of knowledge items in memory is impractical given that each memory value would consist of hundreds of tokens; (2) transformer encoder requires quadratic complexity with respect to the total number of tokens times K for self-attention.

Therefore, an alternative is to use the Perceiver architecture as described by Jaegle et al. in “Perceiver: General perception with iterative attention” (2021), the entire disclosure of which is incorporated herein by reference, as the Value Head 416 to encode and compress knowledge items. The Perceiver model uses a transformer decoder ψ(⋅) with learnable c-length latent embeddings to compress the full token sequence into an arbitrary length c, such that Emb_{Value}(z)=ψ(b(z))∈ [symbol] ^{x×d}. In the testing described further below, c was 32, although other values for c may be utilized (either greater than 32 or less than 32). This enables the system to retrieve top-K memory entries for K as large as hundred.

To make the compressed embeddings generated by Perceiver more expressive, two additional regularizations can be added. The first one is a disentangled regularization such as described by Hu et al. in “Improving multi-task generalization via regularizing spurious correlation (2022), the entire disclosure of which is incorporated herein by reference, which forces every two output tokens to be linearly de-correlated as follows:

$${ℒ}_{decor} = {{\sum }_{i , j = 1}}^{K} {‖ Covariance ( ψ ( b ( {z}_{i} ) ) , ψ ( b ( {z}_{j} ) ) ) ‖}_{F}^{2}$$

The second one is an alignment regularization that minimizes the L2-norm distance between the query and compressed knowledge embedding as follows:

$${ℒ}_{align} = \vert 1 - \frac{{\sum }_{z} {‖ ψ ( b ( z ) ) ‖}_{2}}{{\sum }_{x} {‖ b ( x ) ‖}_{2}} \vert$$

As shown in dashed box (c) (see also FIG. 4B, for a given input query 408, the model's knowledge retriever is configured to retrieve the top-K relevant knowledge items. In this example, it is assumed that the knowledge retriever will do this by first assigning weights to the entries of the corpus at block 420 using a gating network 418, and then finding the most similar knowledge items from its corresponding corpus memory (via input 422 from the unified memory as shown in FIG. 4C). This can be done using a maximum inner product search (MIPS) as shown at block 424. By way of example, approximate search algorithms that scale sub-linearly with the size of the knowledge corpus |C| can be used. By way of example, see Chern et al., “TPU-KNN: K nearest neighbor search at peak flop/s” (2022), as well as Shrivastava et al, “Asymmetric LSH (ALSH) for sublinear time maximum inner product search (MIPS)” (2014), the entire disclosures of which are incorporated herein by reference. A distributed MIPS search can be performed by splitting and storing the memory embeddings across all training devices. Here, the query is synced to each device, which retrieves approximate top-K results from its own memory. Then these results are combined to compute the global top-K retrieved items.

Once the top-K relevant knowledge items have been identified at 426, and a lookup by index at block 428 is performed using the values 414 and/or keys/values 430 from memory (see FIG. 4C), the model may return the pre-computed in-memory value embeddings for those entries, as shown by block 432. Likewise, in some aspects, the model may be configured to re-encode the raw knowledge data of those entries in order to use up-to-date value embeddings for each of the retrieved top-K knowledge items, as shown by block 434. Further details regarding how an exemplary knowledge retriever may identify the top-K memory entries for a given query and generate retrieval scores for each identified entry are now discussed.

Given the input query x, the retriever's task is to find top-K memory entries M with the highest probability p(M|x), which can be approximated as p(M|x)=Π_{m∈M}p(m|x) by retrieving each entry independently. Note that the system can retrieve from a large-scale unified memory [symbol] =[ [symbol] ¹, . . . , [symbol] ] that is constructed from a diverse set of knowledge sources as noted above. To help the query to better choose the most appropriate knowledge sources, the system can learn a gating function that models the probability of retrieving from each memory corpus. With the corpus gating, for

$${m}_{i}^{j} ∈ {\text{?}}^{j} ,$$

the system can re-weight p(m^{j}|x) by the computed corpus gating score:

$$\begin{matrix}p ( {m}_{i}^{j} \vert x ) = p ( {ℳ}^{j} \vert x ) \cdot p ( {m}_{i}^{j} \vert x ; {ℳ}^{j} ) & ( 2 ) \\ = {Gate}_{{ℳ}^{j}} ( x ) \cdot \frac{exp ( Rel ( x , {m}_{i}^{j} ) / τ )}{{\sum }_{{m}_{j}^{k} ∈ {ℳ}^{j}} exp ( Rel ( x , {m}_{k}^{j} ) / τ )} & ( 3 )\end{matrix}$$

Here, Gate_{Mj}(x)=Softmax(W·Emb_{Query}(x)+b)[j] is a softmax gating that assigns a score to each memory corpus M, with W and b as function parameters.

$$Rel ( x , {m}_{i}^{j} )$$

models relevance score between query x and each memory entry via embedding dot product, such that

$$Rel ( x , {m}_{i}^{j} ) = {{Emb}_{Quert} ( x )}^{T} \cdot {Emb}_{Key} ( {z}_{i}^{j} ) ,$$

where zᵢ is the knowledge item corresponding to the memory entry mᵢ and τ is the temperature parameter. After identifying the top-K memory entries, the retriever passes the pre-computed in-memory key and value embeddings to the generator. In the meantime, to support end-to-end training of the encoders, the system may re-encode a small portion (e.g., on the order of 5-15%, such as 10%, or more or less) of the retrieved knowledge items zᵢ from scratch. In this way, the memory encoders can be updated with moderate computational cost. The reencoded knowledge is concatenated with in-memory ones to construct the final top-K retrieved key/value embeddings.

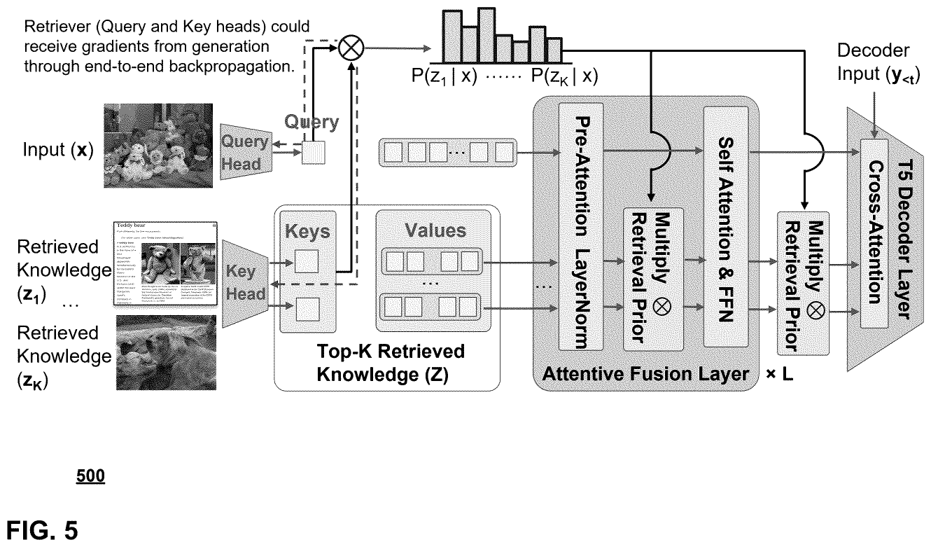

Finally, as shown in dashed box (d) (see enlarged view in FIG. 4B), the model is configured to fuse the value embeddings of the top-K knowledge items 436 via the attentive knowledge fusion model 438 to generate a final output. As described further below with respect to FIG. 5, it is assumed that this fusion layer will also inject the retrieval score for each knowledge item as a prior every time the attention score is calculated. Further details regarding how an exemplary model may fuse the top-K memory entries and generate a final output are discussed below.

FIG. 5 is a flow chart illustrating an exemplary process flow 500 for an attentive knowledge fusion module (e.g., attentive knowledge fusion model 438) of a retrieval-augmented visual-language model, in accordance with aspects of the disclosure. In that regard, in order to guide the model's generator to attend to the most important memory entries, and also be able to backpropagate the resulting gradients back to the retriever, the model may use an attentive fusion layer that is configured to incorporate each entry's retrieval score as a prior to calculate cross-knowledge attention. One exemplary process flow for doing this is shown pictorially in FIG. 5, and further details are as follows.

As shown in FIG. 4B, the attentive knowledge fusion model 438 takes as input a query embedding 440 (as output from section (a) and the top-K knowledge items 436. And as shown in FIG. 5, the fusion model is configured to concatenate all the K retrieved memory values with the query embedding. This can be easily performed since the system can use a Perceiver module as the value head w (⋅) that compresses each knowledge item into a short sequence. The concatenated query embedding and memory values is denoted as X=[b(x), ω(b(z₁)), . . . , ψ(b(z_{K}))]∈ [symbol] ^{(I+c·K)×d}, where I is the number of tokens of the input query x and c is the number of compressed tokens. In order to guide the generator to attend to the most important items in X and also be able to backpropagate the gradients back to the retriever, the attentive fusion module f(⋅) is able to incorporate a retriever score as a prior to calculate cross knowledge attention. For instance, retrieval probability is injected as a prior to knowledge token embeddings, so the retriever can receive gradients via backpropagating over the {self/cross}-attention part.

As shown in FIG. 5, the model may firstly computes a latent soft attention mask over X as Maskₐₜₜ=[1, p(z₁|x), . . . , p(z_{K}|x)]. Taking both X and Maskₐₜₜ as input, the attention fusion module multiplies the mask Maskₐₜₜ to each retrieved knowledge per Transformer layer after Layemorm before attention calculation. In this way, the outward attention score for the token in each knowledge item is proportional to the retrieval probability. This allows the retrieval model be backpropagated to weight the important knowledge items higher through end-to-end training. Note that the independent decoding methods could be regarded as applying a hard one-hot Masking, and our method is more general and could learn in differentiable manner. For independent decoding, see, e.g., Guu et al, “REALM: retrieval-augmented language model pre-training (2020), as well as Sachan et al, “End-to-end training of multi-document reader and retriever for open-domain question answering” (2021), the entire disclosures of which are incorporated herein by reference. Finally, the fused representation f(X, Maskₐₜₜ) is passed into a T5 decoder module g(⋅) (see 442 in FIG. 4B) to generate the textual output.

### Generative Pre-Training

It has been found that existing VQA datasets may not be large enough for training a complex multi-component model from scratch. Therefore, according to one aspect of the technology, the process can include pre-training the model on a massive image-text corpus. The following discussion goes over the details of the pre-training data and objective, the various sources of knowledge used in testing that was conducted, and pre-training implementation details are also discussed.

In one scenario, the model was pre-trained on the Web-Image-Text dataset (discussed by Zhai et al in “Lit: Zero-shot transfer with locked-image text tuning” (2022), the entire disclosure of which is incorporated herein by reference), a large-scale corpus containing 3 billion image alt-text caption pairs collected from the public Web. Since the dataset was found to be noisy, a filter was added to remove data points whose captions are shorter than 50 characters. This yields roughly 1.3 billion image caption pairs for pre-training.

The pre-training Web-Image-Text dataset is denoted as [symbol] . The text generation objective discussed by Wang et al in “Simvlm: Simple visual language model pretraining with weak supervision” (2022) (the entire disclosure of which is incorporated herein by reference) was used to pre-train the model on [symbol] . Given an image-text example x=(img, txt) from [symbol] , the process randomly samples a prefix length Tₚ. Next, x_{<T}_{ₚ} that contains the text prefix and image is fed to the model as input and the objective is to generate x_{≥T}_{ₚ} containing the rest of the text as output. The training goal is to condition on x_{<T}_{ₚ} and autoregressively generate the remaining text sequence x_{≥T}_{ₚ}:

$$\begin{matrix}{ℒ}_{PrefixLM} = - {𝔼}_{x ∼ D} [ log p ( {x}_{\geq {T}_{p}} \vert {x}_{< {T}_{p}} ) ] \\ = - {𝔼}_{x ∼ D} [ {\sum }_{i \geq {T}_{p}} log p ( {x}_{i} \vert {x}_{< i} ) ]\end{matrix} . \qquad ( 4 )$$

In order to pre-train all components of our model end-to-end, the retriever may be warm started at a “good” state. Otherwise, if starting with random weights, the retriever can return irrelevant memory items that would never generate useful training signals. To avoid this cold-start problem, an initial retrieval dataset can be constructed with pseudo ground-truth knowledge to give the pre-training a reasonable head start. A modified version of the Wikipedia-Image-Text (WIT) dataset (see Srinivasan et al, “WIT: Wikipedia-based image text dataset for multimodal multilingual machine learning”, 2021, the entire disclosure of which is incorporated herein by reference) was created for this purpose. Each image-caption pair in WIT also comes with a corresponding Wikipedia passage (words surrounding the text). The surrounding passage was put together with the query image and used as the pseudo ground-truth knowledge that corresponds to the input query. As the passage provides rich information about the image and caption, it definitely is useful for initializing the model. To avoid the model from relying on low-level image features for retrieval, y random data augmentation can be applied to the input query image. Given this modified dataset that contains pseudo retrieval ground-truth, the query and memory key embeddings can be trained by optimizing the following contrastive loss:

$${ℒ}_{contra} = - log Softmax ( {{Emb}_{Query} ( x )}^{T} {Emb}_{Key} ( \hat{z} ) )$$

where \hat{z} represents the pseudo ground-truth knowledge entry corresponding to the input query x.

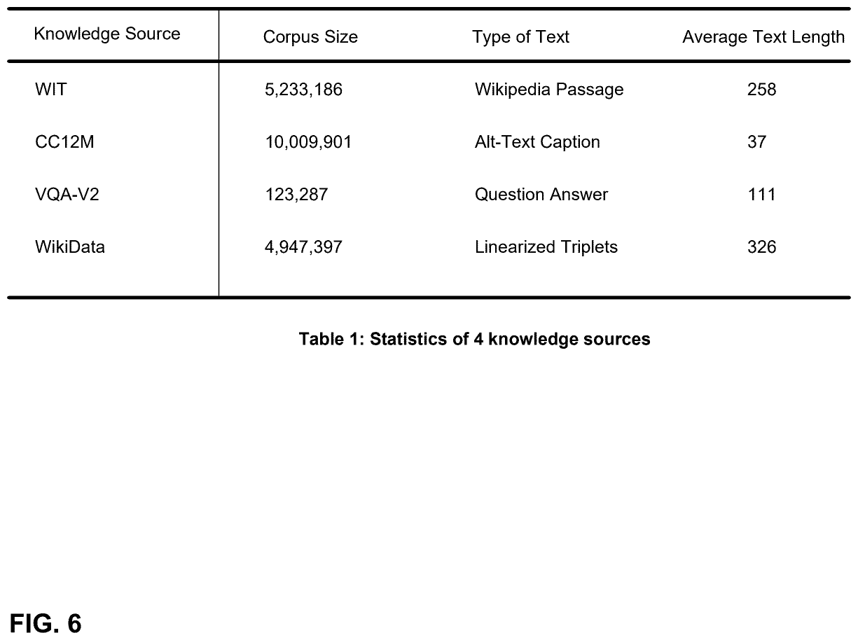

The following four sources of knowledge were used in the experiments. (1) WIT, noted above, which includes the images in Wikipedia as well as their alt-text captions and contextualized passages. (2) Conceptual (or “CCl2M”), described by Changpinyo et al in “Conceptual l2M: Pushing web-scale image-text pretraining to recognize long-tail visual concepts (2021), that contains web images paired with alt-text captions. It contains many long-tail entities. (3) VQA-v2, described by Goyal et al in “Making the V in VQA matter: Elevating the role of image understanding in visual question answering, 2019), which is a visual question answering dataset. For testing, all question-answer pairs per image were merged into a single passage. And (4), WikiData, described by Vrandecic et al in “Explicit knowledge-based reasoning for visual question answering (2017)”, which is a structural knowledge graph encoding relations between Wikipedia entities. For testing, all relational triplets per entity were linearized into a textual passage following the procedure described by Oguz et al in “Unified open-domain question answering with structured and unstructured knowledge “(2020). The entire disclosures of each of these references (i.e., 1-4 and Oguz) are incorporated herein by reference. The statistical details of these knowledge sources are presented in Table 1 of FIG. 6.

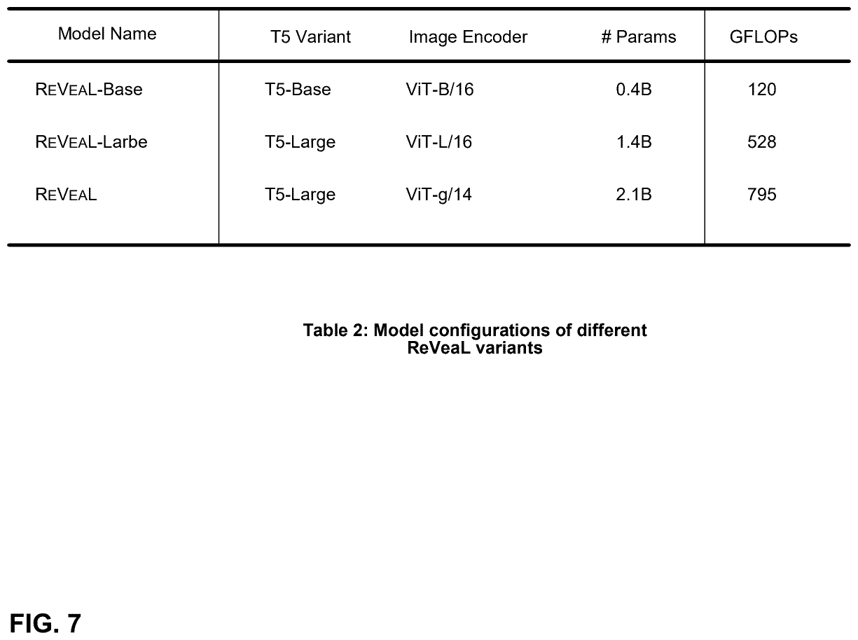

Incorporating all the components introduced above, the REVEAL model can be directly pre-trained over large-scale image caption datasets after proper initialization. As the model architecture is based on T5 and ViT, pre-trained ViT checkpoints were used as described by Zhai et al in “Scaling vision transformers”, 2022 (the entire disclosure of which is incorporated by reference herein), and pre-trained T5 checkpoints as described by Raffel et al in “Exploring the limits of transfer learning with a unified text-to-text transformer”, 2020 (the entire disclosure of which is incorporated by reference herein), to initialize the encoder parameters. The query head, key head and attentive fusion layers were initialized from upper TS, while the base text encoder was initialized from lower T5. The combination of these modules can be found in Table 2 of FIG. 7 for three model variants: REVEAL-Base, REVEAL-Large and REVEAL, of which the largest REVEAL model has around 2 billion parameters.

Finding the top-k most relevant knowledge entries can be considered a standard Maximum Inner Product Search (MIPS) problem. As noted above, there are approximate search algorithms that scale sub-linearly with the size of the knowledge corpus ICI—The ALSH approach was used to conduct distributed MIPS search, by splitting and storing the memory embeddings across all training devices. The query was synced to each device, which retrieved approximate top-K results from its own memory. Then these results were combined to compute the global top-K retrieved items.

For a pre-training pipeline, first the multimodal retriever was trained on the modified version of the Wikipedia Image Text (WIT) dataset via [symbol] _{contra}. The Adafactor optimizer was used without momentum (/31=0, /32=0.999), with weight decay of 0.0012, and with a peak learning rate of 6e4, to train for 10 epochs. This checkpoint was used to warm-start the generative pre-training. The number of retrieved knowledge entries was set as K=10 during pre-training, and Adafactor was used with a peak learning rate of 1 e-3 and inverse squared root learning rate scheduler with 10,000 linear warm-up steps. [symbol] _{prefixLM} was used as the main objective, adding [symbol] _{contra}, [symbol] _{decor} and [symbol] _{align} weighted by 0.01. A batch size of 4096 was used across 256 CloudTPUv4 chips and trained for about 5 days.

### Testing and Results

The present method was evaluated on knowledge-based VQA, as well as on image captioning. Ablation studies were conducted to analyze the impact of each model component on overall performance.

One of the most knowledge intensive visual-language tasks is knowledge-based visual question answering (VQA), exemplified by the OK-VQA (see Marino et al, “OK-VQA: A visual question answering benchmark requiring external knowledge”, 2019, the entire disclosure of which is incorporated herein by reference) and A-OKVQA (see Schwenk et al, “A-OKVQA: A benchmark for visual question answering using world knowledge”, 2022, the entire disclosure of which is incorporated herein by reference) benchmarks.

To finetune the pre-trained model on these VQA tasks, the same generative objective was used where the model takes in an image question pair as input and generates the text answer as output. There were a few differences between the fine-tuning and the pre-training stages: 1) the number of retrieved knowledge entries was set to K=100, so the model was able to retrieve sufficient supporting evidence; 2) the whole base V-L encoder was frozen as well as the multimodal memory to stabilize training; and 3) a batch size of 128 was used, with the Adafactor optimizer, a peak learning rate of 1e-4, and an inverse square root learning rate scheduler with 1000 steps of linear warmup. The soft VQA accuracy metric (see Antol et al, “VQA: visual question answering”, 2015, the entire disclosure of which is incorporated herein by reference) was used to evaluate the model's generated answer.

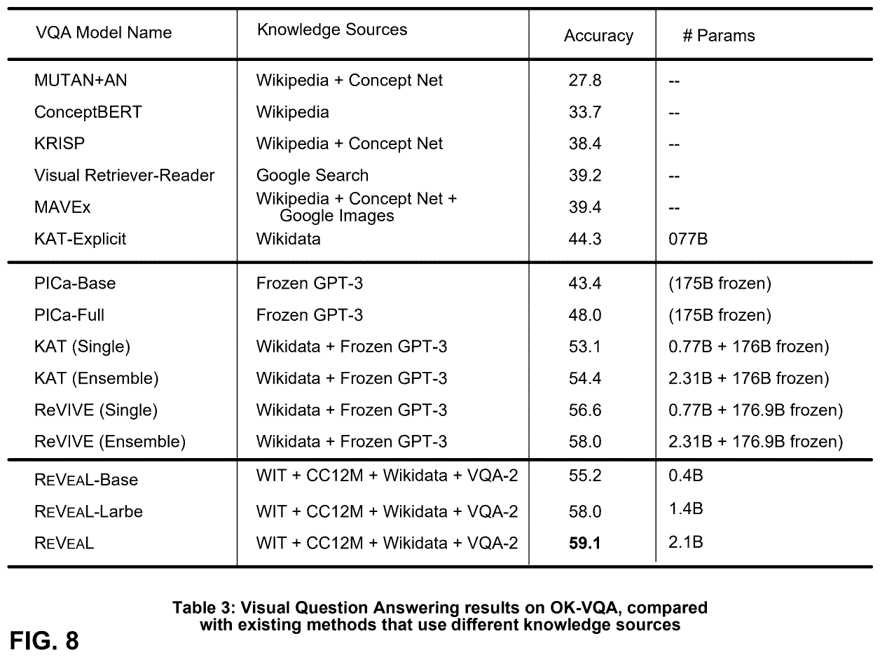

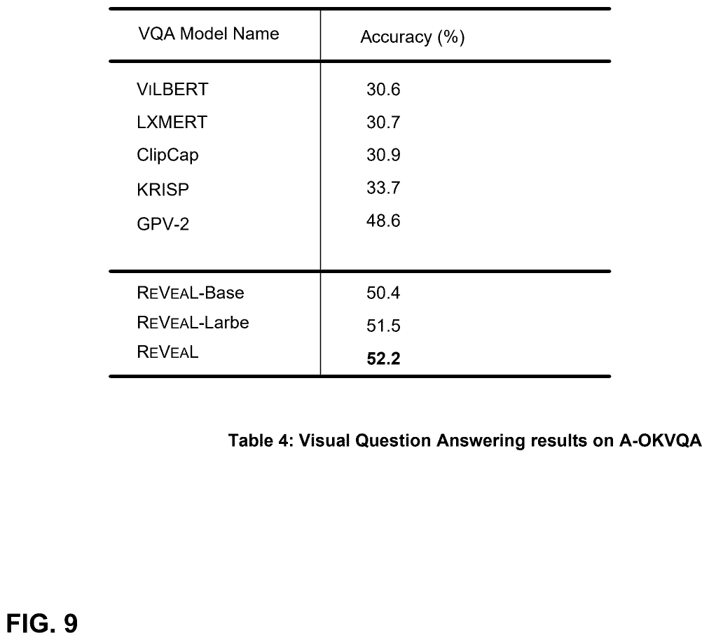

The results on OKVQA and A-OKVQA datasets are shown in Table 3 of FIG. 8 and Table 4 of FIG. 9, respectively. For OKVQA, earlier attempts that incorporate a fixed knowledge retriever report results that are below 45%. Recently a series of works utilize large language models (e.g., GPT-3) as implicit knowledge sources, which achieve much better performance with the trade-off of a huge computational cost. The REVEAL model achieved higher performance than those methods without relying on such large language models. Compared with the previous state-of-the-art, KAT and ReVIVE, which also utilizes T5-Large as a generator, the REVEAL model achieved accuracy of 59.1%, which is +6.0% higher than the single KAT model (see Gui et al, “KAT: A knowledge augmented transformer for vision-and-language”, 2022, the entire disclosure of which is incorporated herein by reference) and +2.5% higher than ReVIVE (see Lin et al, “REVIVE: regional visual representation matters in knowledge-based visual question answering”, 2022, the entire disclosure of which is incorporated herein by reference).

In Table 3 of FIG. 8, in addition to KAT and ReVIVE, the following VQA models were also evaluated against the REVEAL model. MUTAN+AN (see Marino et al., “OK-VQA: A visual question answering benchmark requiring external knowledge, 2019); ConceptBERT (see Garderes et al., “Conceptbert: Concept-aware representation for visual question answering”, 2020); KRISP (see Marino et al. “KRISP: integrating implicit and symbolic knowledge for open-domain knowledge-based VQA”, 2021); Visual Retriever-Reader (see Luo et al., “Weakly-supervised visual-retriever-reader for knowledge-based question answering”, 2021); MAVEx (see Wu et al., “Multi-modal answer validation for knowledge-based VQA”, 2022); and PICa (see Yang et al., “An empirical study of GPT-3 for few-shot knowledge-based VQA”), the entire disclosures of where are incorporated herein by reference.

And in Table 4 of FIG. 9, in addition to KRISP, the following VQA models were also evaluated against the REVEAL model. VILBERT (see Lu et al., “Pretraining task-agnostic visiolinguistic representations for vision-and-language tasks”, 2019); LXMERT (see Tan et al., “LXMERT: learning cross-modality encoder representations from transformers”, 2019); ClipClap (see Mokady et al., “Clipcap: CLIP prefix for image captioning”, 2021); and GPV-2 (see Kamath et al., “Webly supervised concept expansion for general purpose vision models”, 2022), the entire disclosures of which are incorporated herein by reference.

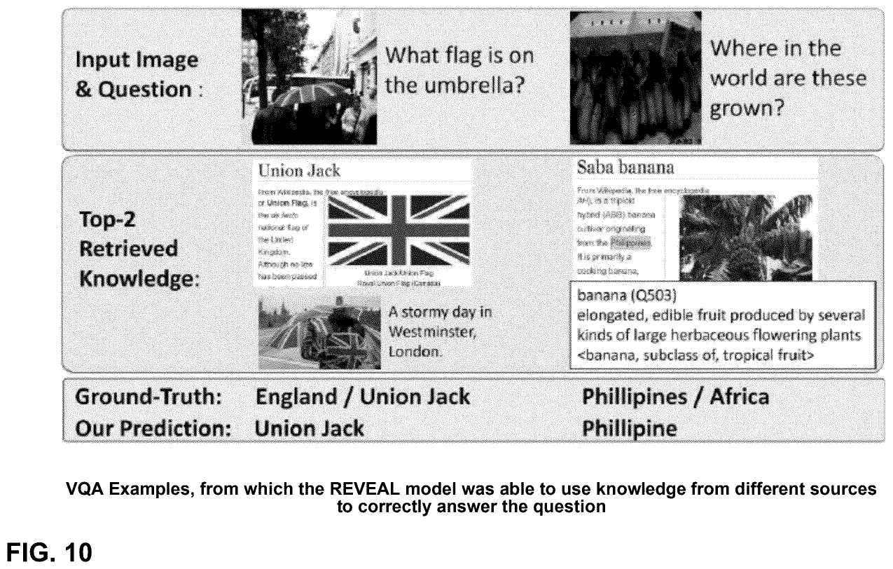

On A-OKVQA, the REVEAL model achieved 52.2% accuracy, which was +3.6% higher than the previous best, GPV-2. Two examples of these datasets are shown in FIG. 10. All these results show that, with proper end-to-end retrieval training and a diverse set of knowledge sources, REVEAL can learn to retrieve meaningful knowledge entries, and achieve promising results without relying on a large language model.

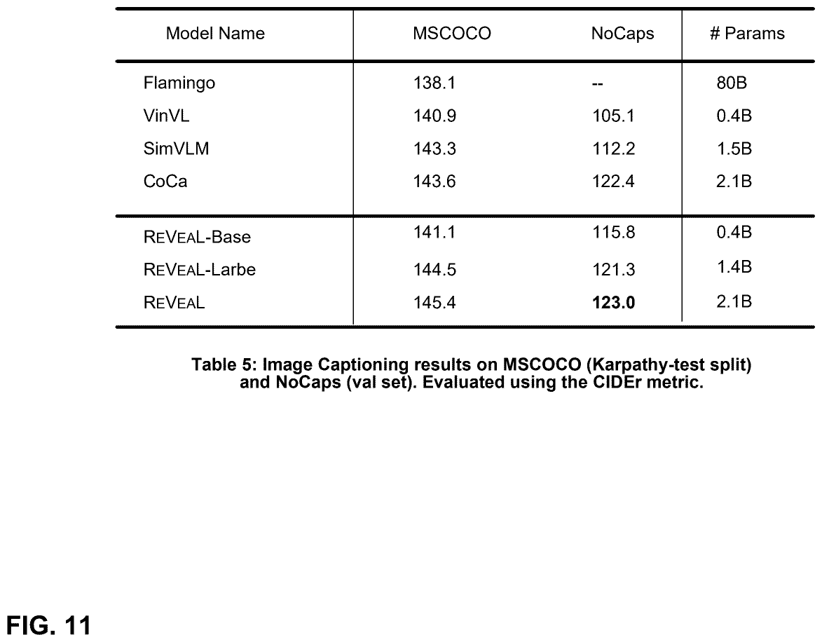

The REVEAL model was also evaluated on the following image captioning benchmarks: MSCOCO Captions (see Chen et al., “Microsoft COCO captions: Data collection and evaluation server”, 2015) and NoCaps (see Agrawal et al., “nocaps: novel object captioning at scale”, 2019), the entire disclosures of which are incorporated herein by reference. The evaluation protocol used by Yu et al., in “Coca: Contrastive captioners are image-text foundation models” (2022) was followed, the entire disclosure of which is incorporated herein by reference. The generator model was directly fine-tuned on the MSCOCO training split via cross-entropy generative objective. Performance was measured on the MSCOCO test split and NoCaps val set with the CIDEr metric (see Vedantam, et al., “Cider: Consensus-based image description evaluation” 2015). The results of these two datasets are shown in Table 5 of FIG. 11. Note that the REVEAL model achieved better results than strong recent baselines such as SimVLM (see Wang et al., “Simvlm: Simple visual language model pretraining with weak supervision”, 2022, the entire disclosure of which is incorporated herein by reference), VinVL (see Zhang et al., “Vinvl: Revisiting visual representations in vision-language models”, 2021, the entire disclosure of which is incorporated herein by reference) and CoCa) on both benchmarks. Notably, REVEAL-Large with 1.4B parameters outperformed the 2.1B-parameter CoCa model and was significantly better than the 80B-parameter Flamingo (see Alayrac et al., “Flamingo: a visual language model for few-shot learning”, 2022, the entire disclosure of which is incorporated herein by reference).

### Analysis of the Effects of Key Model Components

A study was conducted as to which features contributed most to the model's performance. Three questions were focused on: (1) Does the use of multiple knowledge sources contribute to the better performance? (2) Does the proposed attentive fusion outperform existing end-to-end retrieval training methods? And (3) Can one add knowledge by only updating the memory without re-tuning model parameters?

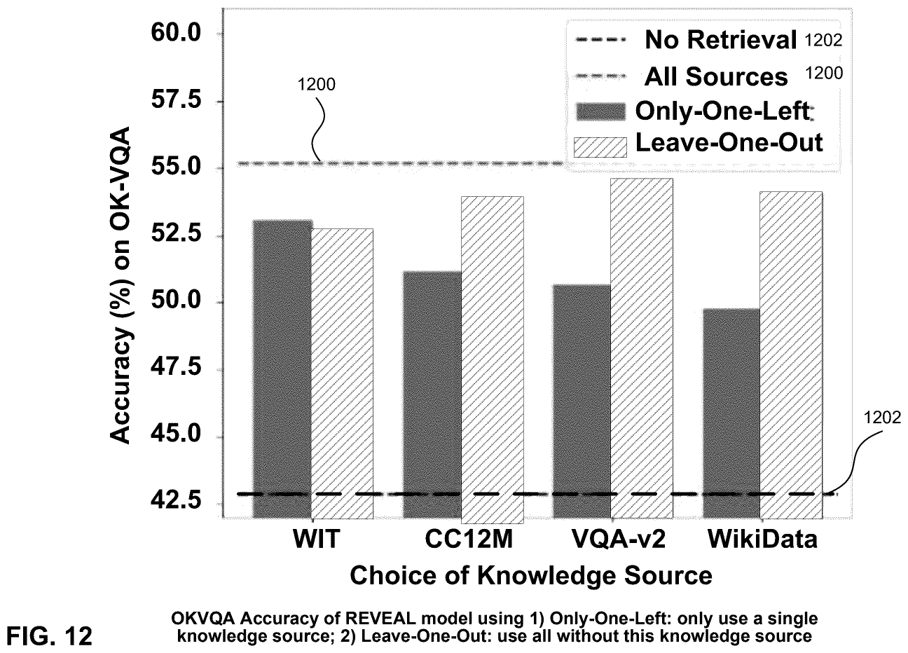

One of the REVEAL model's major differences in comparison to previous retrieval-augmented works is the ability to leverage a diverse set of knowledge sources at inference time. Two ablation studies were performed to measure the relative importance of each data source and the effectiveness of retrieving from a diverse corpus: 1) Only-One-Left: using one knowledge source alone to evaluate the results; and 2) Leave-One-Out: removing one knowledge source from the complete set [symbol] . The ablation studies were performed by using the REVEAL-Base evaluated on the OKVQA val set with these two settings. As shown in FIG. 12, among the four knowledge sources used in this paper, WIT was the most informative, as it had the highest accuracy when used alone (53.1%). The remaining three corpora, CCl2M, VQA-v2 and WikiData were not as informative as WIT when used alone, but removing each of them from the whole corpus still resulted in performance drops of −1.3%, −0.6% and −1.1% respectively. This indicates that the knowledge sources complemented each other, providing useful information to improve performance. Dashed line 1200 indicates all sources, while dashed line 1202 indicates no retrieval.

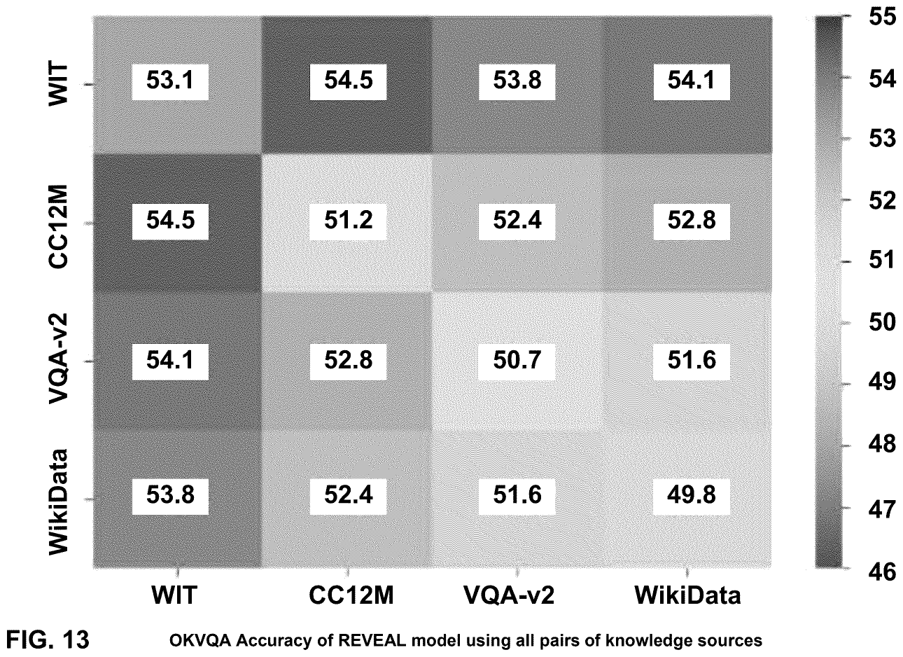

To further support this hypothesis, another experiment was conducted with pairs of knowledge sources, as shown in FIG. 13. Even for a strong knowledge source like WIT, it can be seen that adding an additional corpus to it consistently improved performance.

Another core component of the REVEAL approach is the attentive fusion layer, which supports efficient joint training of the retriever and generator. A study was conducted to see whether it outperformed two categories of existing retrieval training methods: 1) a frozen retriever based on ALIGN representations (see Jia et al., “Scaling up visual and vision-language representation learning with noisy text supervision”, 2021, the entire disclosure of which is incorporated herein by reference); 2) end-to-end retrieval training methods including Attention Distill (see Izacard et al., “Distilling knowledge from reader to retriever for question answering”, 2020, the entire disclosure of which is incorporated herein by reference), EMDR² (see Yang et al., “End-to-end open-domain question answering with bertserini”, 2019, the entire disclosure of which is incorporated herein by reference), and Perplexity Distill (see Izacard et al., “Few-shot learning with retrieval augmented language models”, 2022, the entire disclosure of which is incorporated herein by reference). The pre-trained REVEAL-Base model was used, fixed the generator, and randomly initialized the retriever (query head and key head). The modified version of the WIT dataset was used with pseudo ground-truth retrieved labels as the evaluation corpus. Retrieval performance was evaluated by checking whether the correct passage appeared in top-10/100 results.

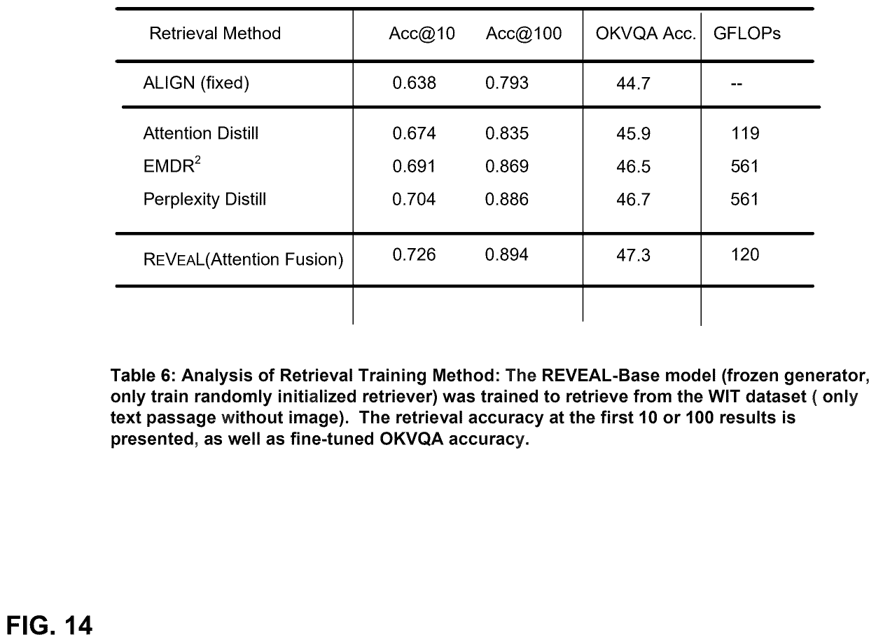

For the ALIGN model, the retrieval results were directly evaluated of pre-trained checkpoint. For the others, retrieval-augmented training was conducted over WIT. To make sure the model would not use image similarity to find the correct results, only the text passage was used as knowledge entry and the image was discarded. Afterwards, the model was finetuned on OKVQA and the accuracy is presented in the test results that are shown in Table 6 of FIG. 14.

It can be observed that directly using pre-trained encoder does not perform well, even with a strong model like ALIGN. Furthermore, among the different end-to-end retrieval training methods, the REVEAL attentive fusion method achieved the best accuracy both in retrieval and in OKVQA. Note that the REVEAL method has a computational cost (measured by GFLOPS) similar to attention distillation, but is much smaller than EMDR² and Perplexity distillation. This indicates that the REVEAL method is more efficient and effective for pre-training the retrieval-augmented visual language model.

One advantage of utilizing knowledge memory is that one could easily add or update knowledge entries without re-training any parameters of the model. To validate this, ablation studies were run in which a certain percentage of the knowledge entries were removed from the corpora, and the REVEAL-Base was evaluated on OKVQA. Then the removed knowledge was added back into the corpora so that the trained model used the full set of corpora to make prediction. In this way, those removed knowledge were not seen by the model during fine-tuning, and one could test whether it could still correctly retrieve and utilize that knowledge to help solve the problem.

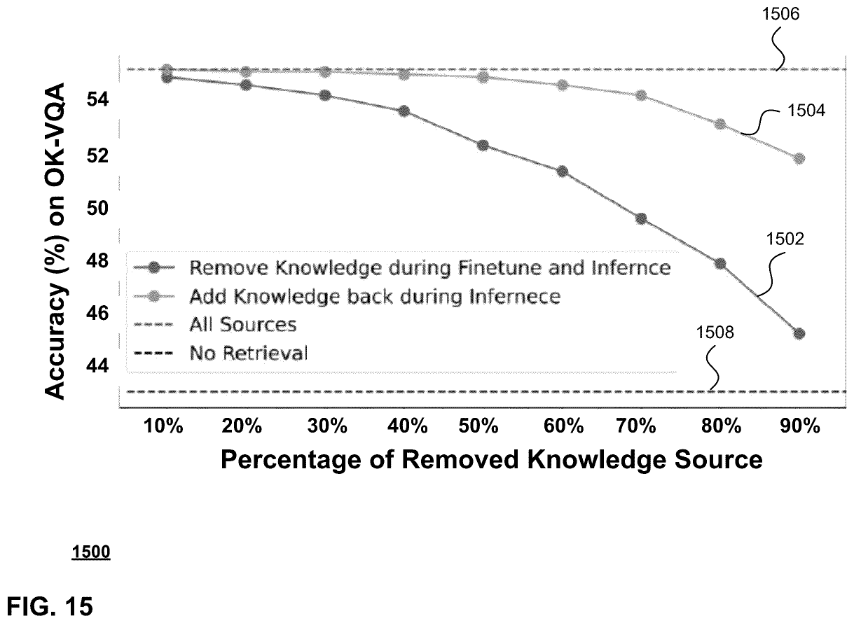

The results of this are shown in plot 1500 of FIG. 15. Here, the curve 1502 show the inference results without removed knowledge, and the curve 1504 shows the results by adding this knowledge back. After adding the knowledge back, one can observe a significant performance improvement against the one with removed knowledge (line 1502). Upper dotted line 1506 indicates all sources, while lower dotted line 1508 indicates no retrieval. Notably, for the model that fine-tuned with only 10% of knowledge, adding the removed knowledge back still achieved 51.8 accuracy (+6.7 higher than removed). This shows that the REVEAL model can quickly adapt to new knowledge by only updating the memory without re-training model parameters.

### Examples of Visual Question Answering and Image Captions

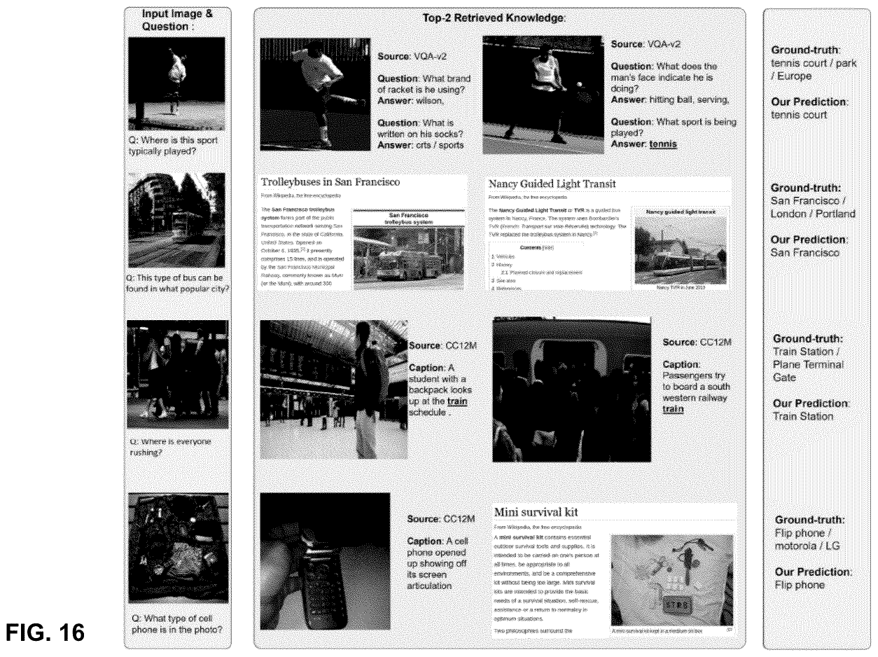

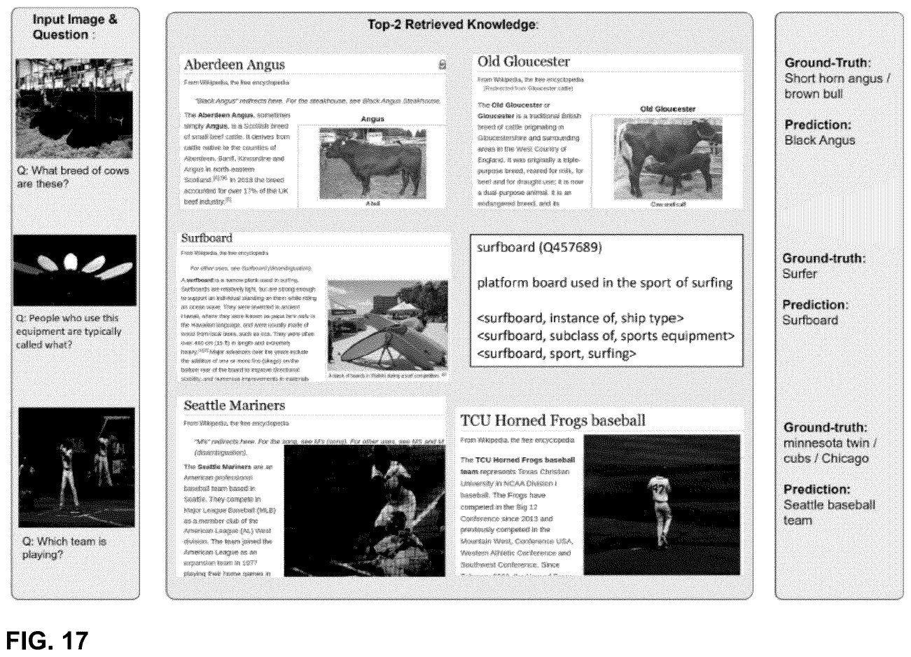

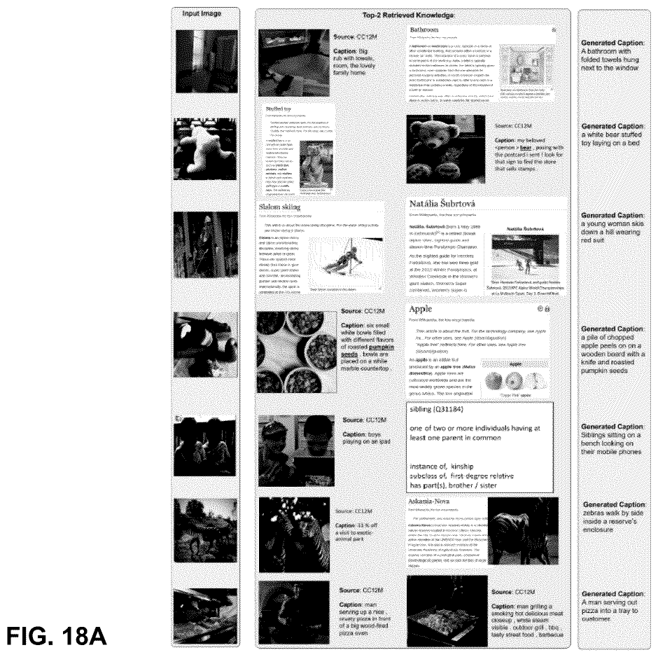

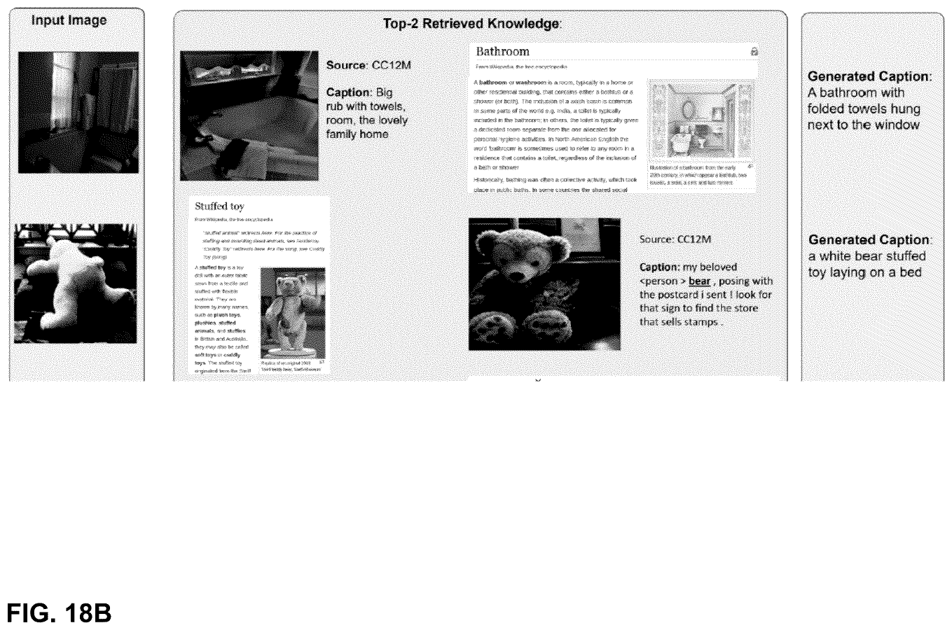

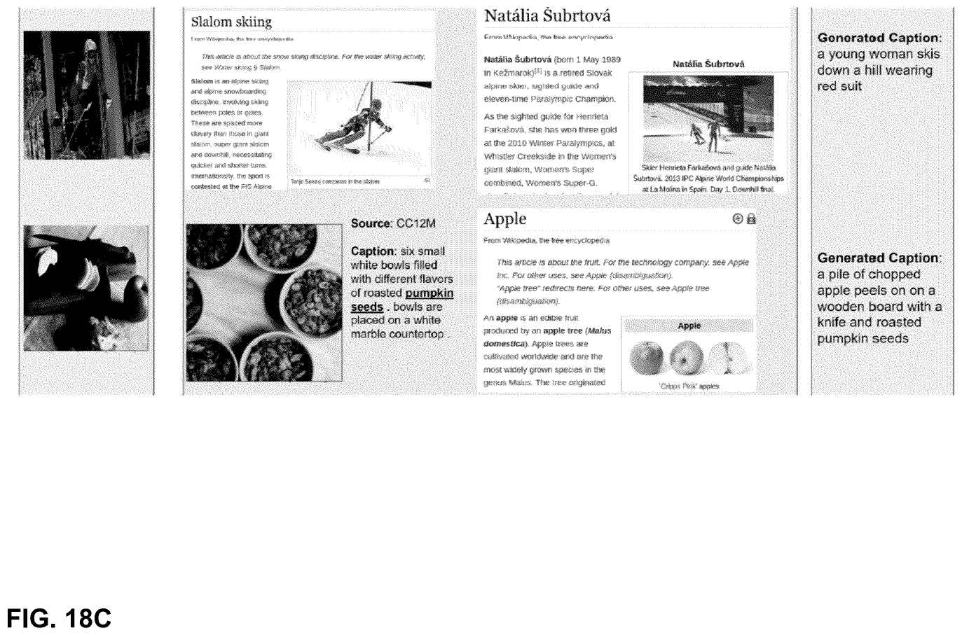

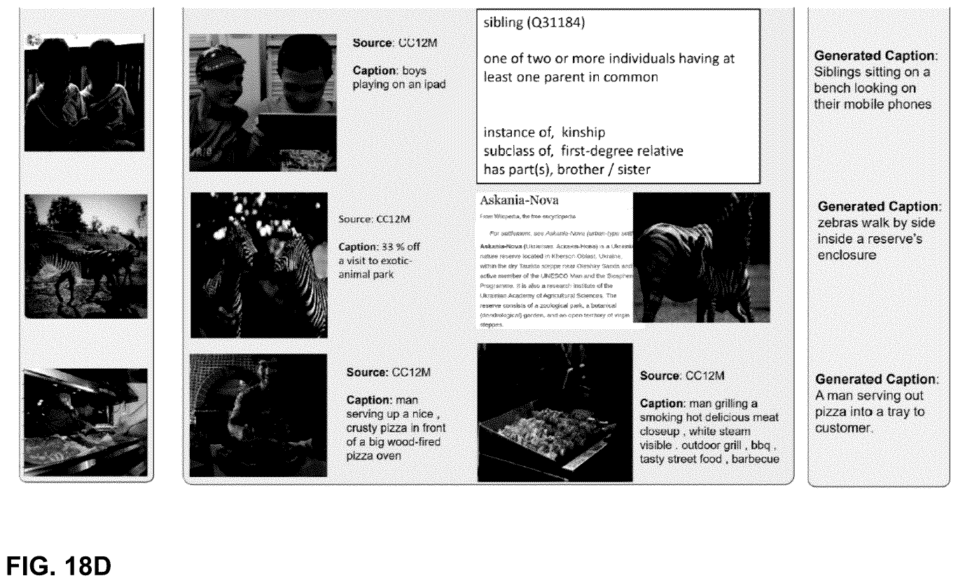

FIGS. 16-18 illustrate examples of visual question answering and image captions. In particular, FIG. 16 illustrates examples of VQA pairs from OKVQA benchmark that the REVEAL model correctly generated the answer. FIG. 17 illustrates examples of VQA pairs from OKVQA benchmark that the REVEAL model made the wrong prediction. And FIGS. 18A-D (with the full set shown in FIG. 18A, and sections shown in FIGS. 18B-D), illustrate examples of generated Caption on MSCOCO image captioning dataset

Note that for visual question answering, four examples were selected that correctly answer the question in FIG. 16, and three examples that the REVEAL model predicts wrongly. For both cases, the REVEAL model could learn to retrieve relevant information from diverse knowledge sources. For example, in the first question in FIG. 16 (“Q: Where is this sport typically played?”), REVEAL retrieves two VQA pairs from VQA-v2 datasets relevant to tennis playing to provide information, and in the second question (“Q: This type of bus can be found in what popular city?”) REVEAL correctly retrieved the Wikipedia page about trolleybus in San Francisco to answer where the bus might appear. The third example (“Q: Where is everyone rushing”) utilizes the image caption pairs from CCl2M, which encodes the commonsense knowledge that a crowd of people might indicate they are rushing towards the train station to catch up deadline. The fourth example (“Q: What type of cell phone is in the photo”) also utilizes the image caption pairs from CCl2M. From this, the model predicted a flip phone. These examples show that the corpus gating module in REVEAL can help identify the most useful knowledge source for different questions. In addition, the Top-100 retrieved knowledge might come from different knowledge sources, and the model could jointly reason with these diverse knowledge entries to get correct answers.

Is was also of interest to see whether the retrieved knowledge still made sense for those QA pairs that REVEAL did not make the correct prediction. FIG. 17 shows such examples. For the first question asking the breed of cows, REVEAL retrieved two species of cow, one from Aberdeen Angus, a formal name for black Angus, and the other is Gloucester. The model's prediction of “Black Angus” was mainly based on the Top-1 retrieved knowledge. Though this prediction is not listed in the ground-truth answers, it is very close to the ground-truth short-horn Angus. Similarly, in the second question that asks the name of surfing equipment, the model retrieved both the Wikipedia page and Wikidata triplets about surfboard and generated this as the answer. Though it is not exactly the same as a ground-truth answer, i.e., “surfer”, it is another way to say about this equipment. Similar to these two examples, there are many other ones for which the model can retrieve relevant information but the predicted results are not the same as the ground-truth. Also, there are several examples in which the retrieved knowledge is less useful. For example, in the third question that asks which baseball team is in the image, though the model retrieved several other baseball teams, they are not the same as the ground-truth ones.

For image captioning, 7 examples are illustrated in FIGS. 18A-D. Though image captioning does not rely too much on outside knowledge, the model can still leverage some retrieved knowledge to generate interesting results. In the 5th example from the top in FIG. 18A (top example in FIG. 18D), the model retrieved the definition of sibling, which is a good guess for the relationship between the two kids in the image, and generates sibling in the output caption. In the 6th example from the top in FIG. 18A (middle example in FIG. 18D), the model retrieved several knowledge relevant to wildlife reserve, and also generated them. Both the VQA and Image Captioning examples show the effectiveness of the retrieval module for these visual-language tasks.

### Hyper-Parameter Sensitivity Analysis

The REVEAL model employs two hyperparameters to achieve suitable performance: the number of compressed tokens c and the number of retrieved knowledge K. Sensitivity analysis was conducted to investigate how the choice of these two hyperparameters influenced final performance during testing.

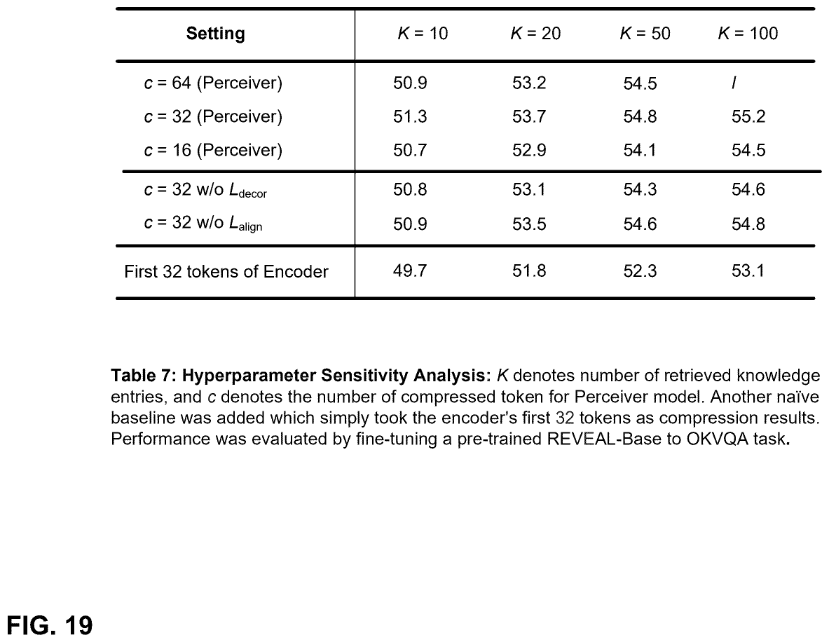

The REVEAL-Base architecture was pre-trained with different compressed tokens c∈[16, 32, 64] with retrieved knowledge K=10. Fine-tuning was performed on downstream OK-VQA datasets with different retrieved knowledge K∈[10, 20, 50, 100]. K was not changed during the pretraining stage because of the vast computational cost of pre-training. K=10 was set as a balance between training effectiveness and scalability. While during fine-tuning, it was straightforward to enumerate different K and study the effects. The results are shown in Table 7 of FIG. 19.

From the results shown in Table 7, it can first be seen that increasing number of retrieved knowledge K can consistently improve the performance, and the improvement is not significantly different from 50 and 100. This fits the hypothesis to jointly reason over multiple knowledge to make correct predictions. To strike a balance between performance and efficiency, one may choose to use K=100 for all fine-tuning tasks, although different values for K may be used (e.g., 50, 75, 125, or more or less).

Regarding value compression, the testing first compared different numbers of compressed tokens c for the Perceiver model. For each different c, the REVEAL-Base version was pre-trained from scratch and reported their fine-tuning results. As is shown in table 7, c=32 achieved the best performance, even higher than c=64. It is surmised that this is because 32 tokens are enough to encode the knowledge information via proper modeling and disentangle regularization. By further increasing the number of tokens, the added capacity will not bring more critical information. Therefore, c=32 was chosen throughout the testing process, although as noted above different values for c may be employed in practice, either higher or lower than 32.

Ablation of the two regularization losses added to guide learning a more informative compression model was also conducted. The results are reported in Table 7 with pre-trained without de-correlation loss [symbol] _{decor} and without alignment loss [symbol] _{align}. As shown in the second block of the table, each regularization loss played an important role in the final performance, and incorporating both can lead to optimal performance.

The testing included further adding another naive baseline for compression: take the first 32 tokens from the encoder, in which b(z) [: 32]. As is illustrated in Table 7, this method performed much worse than Perceiver, likely because the first 32 tokens in the input sentence may not always be the best summarization of the whole knowledge. At the same time, Perceiver could use cross-attention to query the whole sequence properly, and keep the most important information.

### Ablation on Pre-Training Corpus

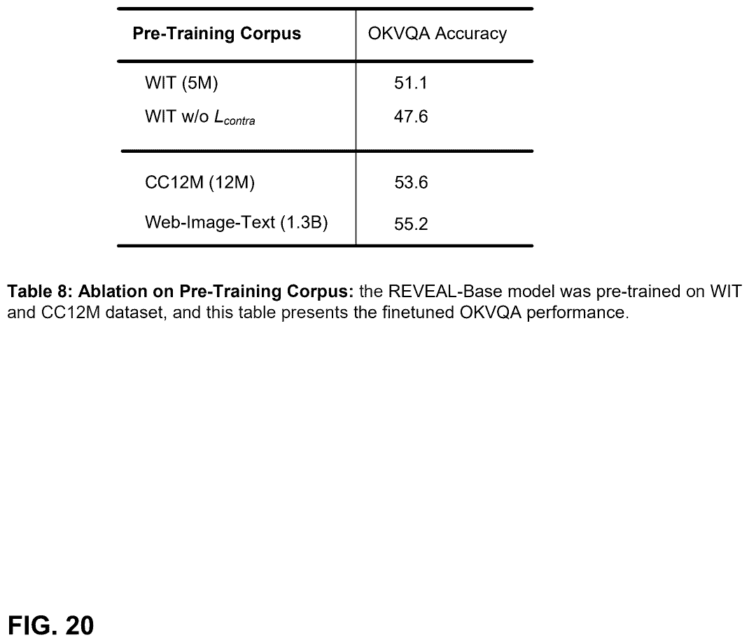

The REVEAL model by default can be pre-trained on the 1 billion Web-Image-Text datasets to achieve good performance. Therefore, one question during testing was whether the performance improvement relies on the large-scale corpus. Therefore, additional testing included two results that pre-trained the model on WIT and CCl2M only. The results are illustrated in Table 8 of FIG. 20. As shown, using a much smaller corpus like CCl2M for pretraining, the performance was −1.6 lower than the one pretrained on 1.3B Web-Image-Text dataset. This shows that our retrieval-augmented pre-training framework is able to obtain good results even with a smaller corpus. By scaling up the pre-training corpus, the model can always learn better generation and retrieval results to achieve optimal performance.

An ablation study was also conducted to remove the retrieval warm-start, [symbol] _{contra}, from WIT. This led to a performance drop of −3.5, as shown in Table 8. This matches the hypothesis that without good initialization for the retrieval module, the retriever may return irrelevant memory items that would never generate proper training signals, leading to the cold-start problem. Therefore, for all results, the testing started with a checkpoint pre-trained on WIT with [symbol] _{contra} as a warm-start.

In a REVEAL approach, one may use the upper-layer T5 module as both the query Headφ_{Query}(⋅) and the key Headφ_{Key}(⋅) to compute the query embedding and memory keys. This allow the model using both visual and textual information to conduct retrieval, but requires further training to fuse the two modality.

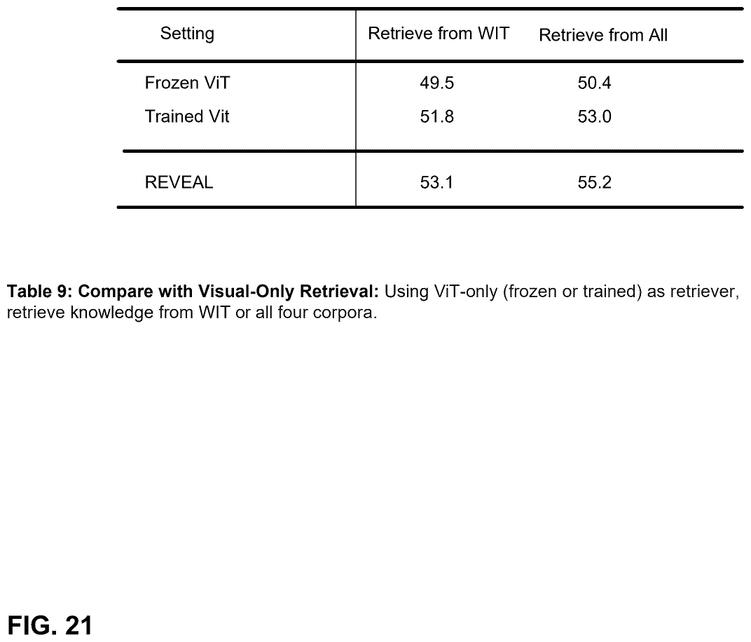

In Table 6, it has been shown that image-to-text matching paradigm (using pre-trained ALIGN) did not perform better than the presently disclosed method. Another straightforward baseline is to only utilize the visual feature, in other words only using the ViT embedding output for retrieval. Testing thus added two additional baselines, which used the frozen ViT (directly from a pre-trained checkpoint without additional training) or trained ViT (using the retrieval-augmented pre-training discussed above, but replace the retrieval head with this ViT) for retrieval. As the knowledge corpora also contained some text-only data such as WikiData, for fair comparison, the REVEAL method was compared with a ViT-based retriever by retrieving from WIT or all the four corpora. As illustrated in Table 9 of FIG. 21, using ViT as the retriever indeed achieved relatively high performance. When retrieving from WIT and all, the trained ViT only achieved performance −1.3 and −2.2 lower, respectively, then the image-text model as the retriever, and significantly higher than using the ALIGN model for retrieval. This shows that the visual feature plays a very important role for retrieving necessary knowledge. Comparing with the frozen ViT, the trained ViT achieved +2.3 and +2.6 higher performance on the two settings. This shows that the retrieval-augmented training presented herein is also useful for getting better retriever, even when directly starting from a strong ViT checkpoint.

### Perceiver as Value Compression Head

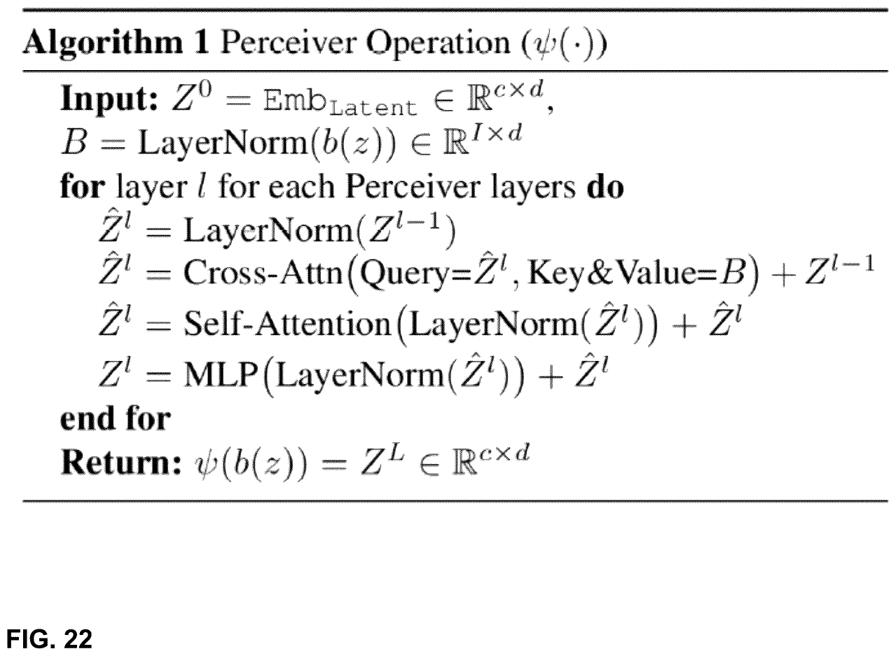

As described above, the full token embedding sequence may be compressed into a shorter sequence by using the Perceiver model. Perceiver is a standard Transformer decoder model that uses a learnable latent embedding Emb_{Latent} as input query, and the full embedding sequence to be compressed b(z) as key and value. For each layer, the perceiver first uses a cross-attention module to compress an l-length full embedding sequence b(z) ∈ [symbol] ^{I×d} into the c-length queries by Emb_{Latent}∈ [symbol] ^{c×d}, followed by self-attention in the latent space. The full compression operation is illustrated as Algorithm 1 (Perceiver Operation ψ(⋅)) in FIG. 22. Note that this algorithm (and the other algorithms discussed herein) may be implemented in any suitable programming language for execution by a processing system using one or more processors.

As shown in FIG. 22, Z^{l} is denoted as l-th layer's output, and \hat{Z}^{l} as an intermediate representation. After stacking L Perceiver layers, the model could learn a meaningful short c-length compressed embedding sequence Z^{L} to represent the original full sequence. To implement Perceiver that is consistent with the remaining model architecture, the standard T5 decoder was used with a randomly initialized latent embedding Emb_{Latent}.

### Attentive Fusion

The following provides details about the attentive fusion module for use in the disclosed model. The attentive fusion module aims to allow end-to-end training of the retriever and generator weights. Without this fusion module, the retriever is not involved in the final answer generation procedure and will not receive gradients.

In particular, the approach is to inject the retrieval score as a soft attention mask into the fusion and decoding process, as is illustrated in FIG. 5. At each Transformer layer before attention calculation, the module multiplies the retrieval probability p(zᵢ|x) to each token embedding belonging to knowledge zᵢ. The concatenated query embedding and memory values are denoted as X=[b(x), ω(b(z₁)), . . . , ω(b(z_{K}))]∈ [symbol] ^{(I+c·K)×d}, where I is the number of tokens of the input query x and c is the number of compressed tokens. Based on the top-K retrieved knowledge Z=[z₁, . . . , z_{K}] with key and value embeddings, one can calculate the probability over these top-K knowledge similar to equation (3) above, as follows:

$$p ( {z}_{i} \vert x ) = \frac{exp ( {Gate}_{ℳℐ ( {z}_{i} )} ( x ) \cdot Rel ( x , {z}_{i} ) / τ )}{{\sum }_{j = 1}^{K} exp ( {Gate}_{ℳℐ ( {z}_{j} )} ( x ) \cdot Rel ( x , {z}_{j} ) / τ )} , \qquad ( 5 )$$

$$\begin{matrix}where Rel ( x , {z}_{i} ) = {{Emb}_{Query} ( x )}^{T} \cdot {Emb}_{Key} ( {z}_{i} ) & ( 6 ) \\ = {{ϕ}_{Query} ( b ( x ) )}^{T} \cdot {ϕ}_{Key} ( b ( {z}_{i} ) ) & ( 7 )\end{matrix}$$

Here, [symbol] I(zᵢ) is denoted as the indicator function returning corpus ID of retrieved knowledge zᵢ, such that

$${\text{?}}^{j} = \text{?} I ( {z}_{i}^{j} ) .$$

Note that the difference of this probability within Top-K results differ with equation (2) in that here there is only summing over the K subset results, and also the gating score is merged into the softmax to make the output a probability that summing to one. The process can then construct a latent soft attention mask over X as:

$${Mask}_{att} = [ [ {\underbrace{1 , … , 1}}_{repeat \times l} ] , [ {\underbrace{p ( {z}_{1} \vert x ) , … , p ( {z}_{1} \vert x )}}_{repeat \times c} ] , … , … , [ {\underbrace{p ( {z}_{K} \vert x ) , … , p ( {z}_{K} \vert x )}}_{repeat \times c} ] ] . \qquad ( 8 )$$

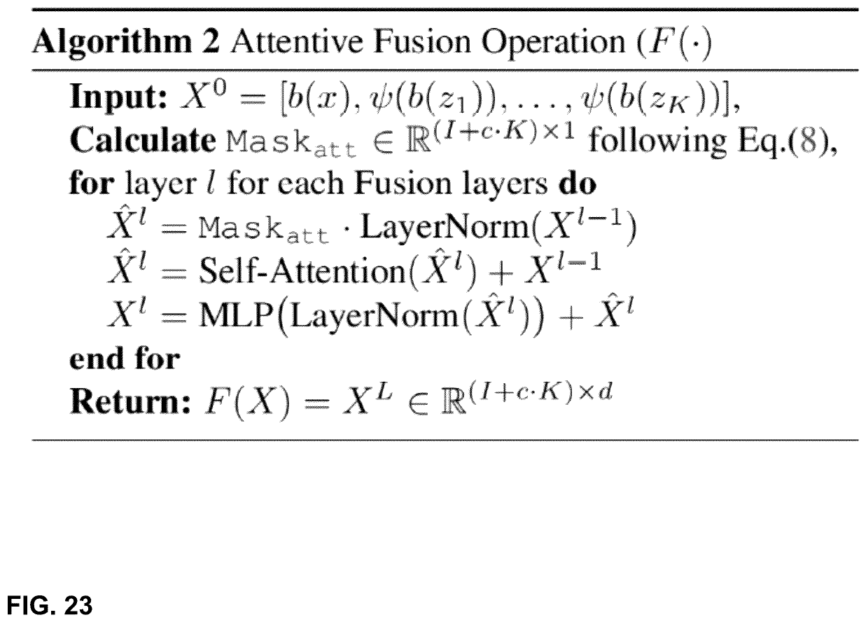

Then, within the attentive fusion module, multiply this attention mask Maskₐₜₜ to the whole embedding sequence. The full attentive fusion operation is presented as Algorithm 2 (Attentive Fusion Operation F(⋅)), illustrated in FIG. 23. Note that this algorithm (and the other algorithms discussed herein) may be implemented in any suitable programming language for execution by a processing system using one or more processors.

In Algorithm 2, X^{l} is denoted as the l-th layer's output, and \hat{X}^{l} as an intermediate representation. The difference is shown in equation (4), in which Maskₐₜₜ is multiplied to the pre-normalized representation (T5 utilizes pre-norm, which is suitable here). In this way, when calculating the attention within the self-attention operation, the attention scores each knowledge sends to other position a_{:,i} is proportional to p(zᵢ|x). This reflects the importance of this knowledge zᵢ to make the final prediction. By multiplying the retrieval score as prior and through end-to-end training, the retriever can be learned to identify those samples that are more important to final output generation. This is similar to adopting a posterior estimation p(z|x, y), which takes output answer as a condition, to optimize the retriever model more effectively.

This modified retrieval injected fusion layer is also similar to the Mixture-of-Expert (MOE) model, in which the retrieval is like a gating layer to select knowledge, and the knowledge representation serves as the expert. In this way, the discrete knowledge retrieval/selection learning can be turned into a continuous learning problem, and the whole model may be learned end-to-end.

### Online Distributed MIPS Retrieval

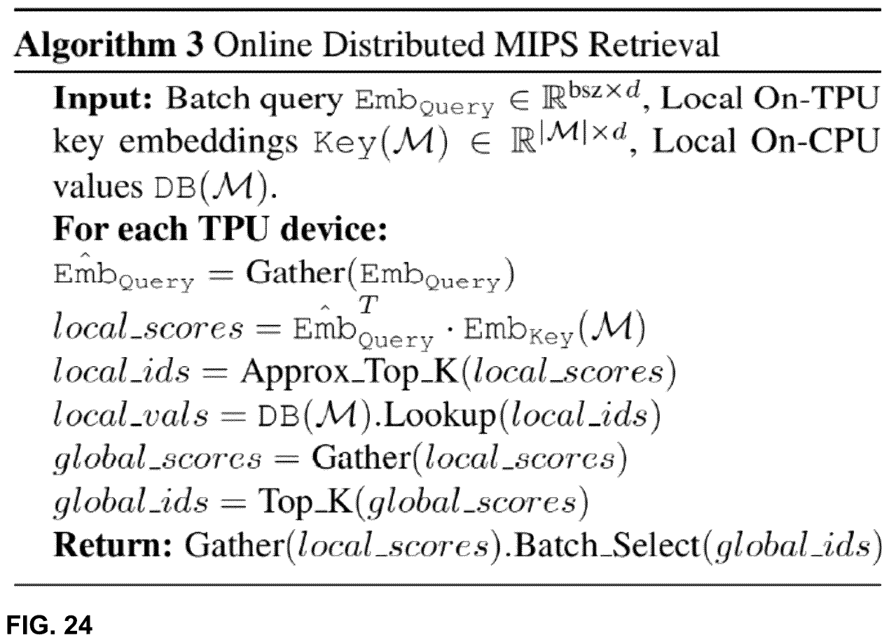

To strike a balance between training efficiency and scalability, the system may store the key embedding memory on a TPU (or other type of processing unit), and store the value sequence embeddings (each sequence may contain, e.g., c=32 token embeddings or more or less) and the raw dataset in the local host's CPU memory (or in another memory). Then, when doing retrieval, each device can first conduct a MIPS operation over on-device memory to find the local Top-K entry ID, then sync the results across the proceeding (e.g., TPU) devices to get the global Top-K, and then return the corresponding results. The detailed procedure in this scenario is shown in Algorithm 3 of FIG. 24. Note that this algorithm (and the other algorithms discussed herein) may be implemented in any suitable programming language for execution by a processing system using one or more processors.

This distributed retrieval can be performed by the processing system in a hierarchical manner if multiple TPUs or other processing devices are grouped into the same host, so the system could first find the Top-K by syncing within each host, and then syncing across host to find global Top-K, which further reduce the communication redundancy.

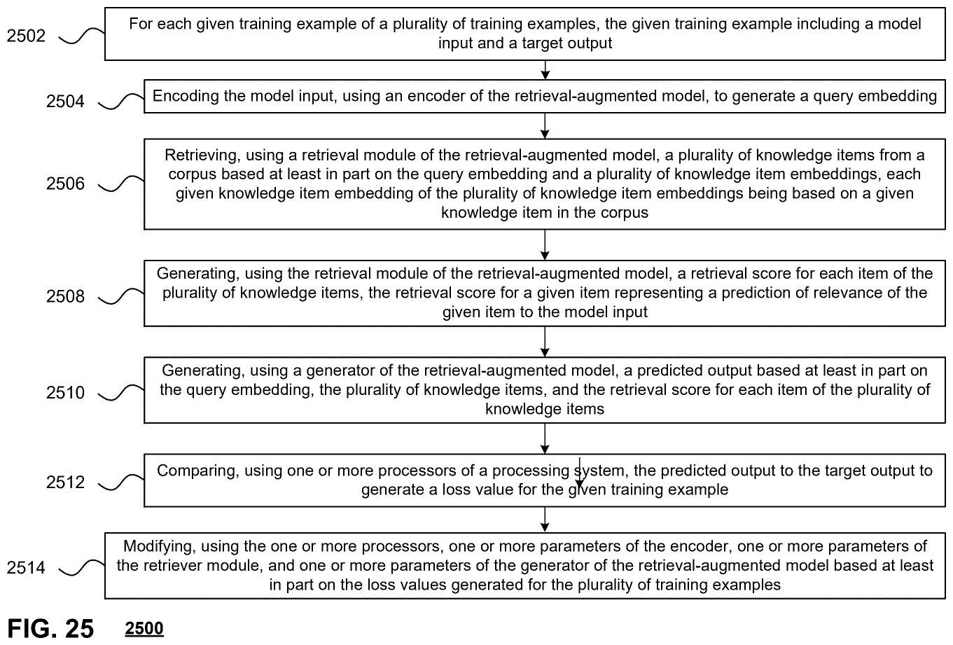

FIG. 25 illustrates a computer-implemented method 2500 of training a retrieval-augmented model. At block 2502, the method denotes the process includes a number of operations for each given training example of a plurality of training examples, in which the given training example including a model input and a target output. At block 2504, the method includes encoding the model input, using an encoder of the retrieval-augmented model, to generate a query embedding. At block 2506, the method includes retrieving, using a retrieval module of the retrieval-augmented model, a plurality of knowledge items from a corpus based at least in part on the query embedding and a plurality of knowledge item embeddings. Each given knowledge item embedding of the plurality of knowledge item embeddings is based on a given knowledge item in the corpus. At block 2508, the method includes generating, using the retrieval module of the retrieval-augmented model, a retrieval score for each item of the plurality of knowledge items. The retrieval score for a given item represents a prediction of relevance of the given item to the model input. At block 2510, the method includes generating, using a generator of the retrieval-augmented model, a predicted output based at least in part on the query embedding, the plurality of knowledge items, and the retrieval score for each item of the plurality of knowledge items. At block 2512, the method includes comparing, using one or more processors of a processing system, the predicted output to the target output to generate a loss value for the given training example. Then the method involves, at block 2514, modifying, using the one or more processors, one or more parameters of the encoder, one or more parameters of the retriever module, and one or more parameters of the generator of the retrieval-augmented model based at least in part on the loss values generated for the plurality of training examples.

There are a number of technical benefits to the technology. These include, by way of example, end-to-end pre-training paradigm that learns to index into a large-scale memory to solve knowledge-intensive visual-language tasks. Another benefit is the construction of a large-scale memory by encoding various sources of multimodal world knowledge, which could include, e.g., Wikipedia passages, web images with alt-text captions, and knowledge graph triplets, etc. Moreover, as shown herein, the model is able to achieve state-of-the-art performance on several knowledge-intensive visual question answering and image captioning datasets.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of exemplary systems and methods should be taken by way of illustration rather than by way of limitation of the subject matter defined by the claims. In addition, the provision of the examples described herein, as well as clauses phrased as “such as,” “including,” “comprising,” and the like, should not be interpreted as limiting the subject matter of the claims to the specific examples; rather, the examples are intended to illustrate only some of the many possible embodiments. Further, the same reference numbers in different drawings can identify the same or similar elements.

1. A computer-implemented method of training a retrieval-augmented model, comprising:
for each given training example of a plurality of training examples, the given training example including a model input and a target output:
encoding the model input, using an encoder of the retrieval-augmented model, to generate a query embedding;
retrieving, using a retrieval module of the retrieval-augmented model, a plurality of knowledge items from a corpus based at least in part on the query embedding and a plurality of knowledge item embeddings, each given knowledge item embedding of the plurality of knowledge item embeddings being based on a given knowledge item in the corpus;
generating, using the retrieval module of the retrieval-augmented model, a retrieval score for each item of the plurality of knowledge items, the retrieval score for a given item representing a prediction of relevance of the given item to the model input;
generating, using a generator of the retrieval-augmented model, a predicted output based at least in part on the query embedding, the plurality of knowledge items, and the retrieval score for each item of the plurality of knowledge items; and
comparing, using one or more processors of a processing system, the predicted output to the target output to generate a loss value for the given training example; and
modifying, using the one or more processors, one or more parameters of the encoder, one or more parameters of the retriever module, and one or more parameters of the generator of the retrieval-augmented model based at least in part on the loss values generated for the plurality of training examples.

2. The method of claim 1, wherein the plurality of knowledge item embeddings comprises a key-value embedding pair for each knowledge item in the corpus.

3. The method of claim 1, further comprising:
generating, using the retrieval-augmented model, each given knowledge item embedding of the plurality of knowledge item embeddings based on a given knowledge item in the corpus.

4. The method of claim 1, further comprising:
modifying, using the one or more processors, one or more knowledge item embeddings of the plurality of knowledge item embeddings based at least in part on the loss values generated for the plurality of training examples.

5. The method of claim 1, wherein one or more of the plurality of knowledge items in the corpus comprises text data.

6. The method of claim 1, wherein one or more of the plurality of knowledge items in the corpus comprises image data.

7. The method of claim 1, wherein one or more of the plurality of knowledge items in the corpus comprises audio data.

8. The method of claim 1, wherein one or more of the plurality of knowledge items in the corpus comprises video data.

9. The method of claim 1, wherein the model input of at least one of the plurality of training examples comprises text data.

10. The method of claim 1, wherein the model input of at least one of the plurality of training examples comprises image data.

11. The method of claim 1, wherein the model input of at least one of the plurality of training examples comprises audio data.

12. The method of claim 1, wherein the model input of at least one of the plurality of training examples comprises video data.

13. The method of claim 1, further comprising:
generating, using the one or more processors, a given training example of the plurality of training examples based on a given knowledge item of the plurality of knowledge items.

14. The method of claim 13, wherein generating the given training example comprises masking a portion of the knowledge item to generate the model input.

15. The method of claim 14, wherein generating the given training example comprises using some or all of the given knowledge item as the target output.

16. A processing system comprising:
a memory storing a retrieval-augmented model; and
one or more processors coupled to the memory and configured to train the retrieval-augmented model according to a training method causing the one or more processors to:
for each given training example of a plurality of training examples, the given training example including a model input and a target output:
encode the model input, using an encoder of the retrieval-augmented model, to generate a query embedding;
retrieve, using a retrieval module of the retrieval-augmented model, a plurality of knowledge items from a corpus based at least in part on the query embedding and a plurality of knowledge item embeddings, each given knowledge item embedding of the plurality of knowledge item embeddings being based on a given knowledge item in the corpus;
generate, using the retrieval module of the retrieval-augmented model, a retrieval score for each item of the plurality of knowledge items, the retrieval score for a given item representing a prediction of relevance of the given item to the model input;
generate, using a generator of the retrieval-augmented model, a predicted output based at least in part on the query embedding, the plurality of knowledge items, and the retrieval score for each item of the plurality of knowledge items; and
compare, using the one or more processors, the predicted output to the target output to generate a loss value for the given training example; and
modify, using the one or more processors, one or more parameters of the encoder, one or more parameters of the retriever module, and one or more parameters of the generator of the retrieval-augmented model based at least in part on the loss values generated for the plurality of training examples.

17. The system of claim 16, wherein the one or more processors are further configured to generate, using the retrieval-augmented model, each given knowledge item embedding of the plurality of knowledge item embeddings based on a given knowledge item in the corpus.

18. The system of claim 16, wherein the training method further comprises modifying, using the one or more processors, one or more knowledge item embeddings of the plurality of knowledge item embeddings based at least in part on the loss values generated for the plurality of training examples.

19. The system of claim 16, wherein the one or more processors are further configured to generate a given training example of the plurality of training examples based on a given knowledge item of the plurality of knowledge items.

20. The system of claim 19, wherein the one or more processors are further configured to generate the given training example by masking a portion of the knowledge item to generate the model input.

21. The system of claim 20, wherein the one or more processors are further configured to generate the given training example by using some or all of the given knowledge item as the target output.

22. The system of claim 16, wherein the retrieval-augmented model is a transformer.

23. The system of claim 22, wherein the training method further comprises, for each given training example of the plurality of training examples, generating, using an attentive fusion module of the retrieval-augmented model, an attention score based at least in part on the retrieval score for each item of the plurality of knowledge items; and
wherein the one or more processors are further configured to generate the predicted output based at least in part on the attention score.

24. The system of claim 16, wherein the retrieval-augmented model is a retrieval-augmented visual-language model.
